(19) United States
(12) Patent Application Publication
(10) Pub. No.: US 2025/0327998 A1
(43) Pub. Date: Oct. 23, 2025

(54) OPTICAL SYSTEM AND CAMERA MODULE COMPRISING SAME

(71) Applicant: LG INNOTEK CO., LTD., Seoul (KR)

(72) Inventor: Duk Keun KWON, Seoul (KR)

(73) Assignee: LG INNOTEK CO., LTD., Seoul (KR)

(21) Appl. No.: 18/866,227

(22) PCT Filed: May 18, 2023
(86) PCT No.: PCT/KR2023/006803

§ 371 Date: Nov. 15, 2024

(30) Foreign Application Priority Data
May 18, 2022 (KR) 10-2022-0061129

(51) Int. Cl. G02B 13/18; G02B 9/64

(52) U.S. Cl. CPC G02B 13/18; G02B 9/64

(57) ABSTRACT

The optical system disclosed in the embodiment of the invention includes first to seventh lenses arranged along an optical axis from an object side to a sensor side, wherein an object-side surface of the first lens is convex, at least one of an object-side surface and a sensor-side surface of the sixth lens has at least one critical point, each of an object-side surface and a sensor-side surface of the seventh lens has a critical point, at least one of the object-side surface and the sensor-side surface of the seventh lens has a freeform surface shape in which a lens surface orthogonal to the optical axis in a first direction and a lens surface orthogonal to the optical axis in a second direction are asymmetrical, and the freeform surface may have symmetrical lens surfaces on both sides of the first direction with respect to the optical axis and symmetrical lens surfaces on both sides of the second direction with respect to the optical axis.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

Therefore, a new optical system capable of solving the above problems is required.

### DISCLOSURE

### Technical Problem

An embodiment of the invention provides an optical system with improved optical properties.

An embodiment provides an optical system having excellent optical performance at the center and periphery portions of the field of view.

An embodiment provides an optical system capable of having a slim structure.

### Technical Solution

An optical system according to an embodiment of the invention comprises first to seventh lenses arranged along an optical axis from an object side to a sensor side, wherein an object-side surface of the first lens is convex, at least one of an object-side surface and a sensor-side surface of the sixth lens has at least one critical point, each of an object-side surface and a sensor-side surface of the seventh lens has a critical point, at least one of the object-side surface and the sensor-side surface of the seventh lens has a freeform surface shape in which a lens surface orthogonal to the optical axis in a first direction and a lens surface orthogonal to the optical axis in a second direction are asymmetrical, and the freeform surface may have symmetrical lens surfaces on both sides of the first direction with respect to the optical axis and symmetrical lens surfaces on both sides of the second direction with respect to the optical axis.

According to an embodiment of the invention, each of the object-side surface and the sensor-side surface of the sixth lens has a critical point, and the critical point of the object-side surface of the seventh lens is the critical point of the object-side surface and the sensor-side surface of the sixth lens. may be positioned closer to the optical axis.

According to an embodiment of the invention, each of the object-side surface and the sensor-side surface of the seventh lens has a critical point, and the critical point of the object-side surface of the seventh lens may be located closer to the optical axis than the critical points of the object-side surface and the sensor-side surface of the sixth lens.

According to an embodiment of the invention, the sixth lens may include regions having different thicknesses at the same radial position in the first direction and the second direction orthogonal to the optical axis.

According to an embodiment of the invention, the seventh lens may include regions having different thicknesses within the same radius in different axial directions between the first direction and the second direction with respect to the optical axis.

According to an embodiment of the invention, the sixth lens may include regions having different thicknesses within the same radius in different axial directions between the first direction and the second direction orthogonal to the optical axis.

According to an embodiment of the invention, the seventh lens may include regions having different thicknesses within the same radius in different axial directions between the first direction and the second direction orthogonal to the optical axis.

According to an embodiment of the invention, a maximum angle between a normal line perpendicular to a tangent passing through the sensor-side surface of the sixth lens and the optical axis may have different angles in the first direction and the second direction orthogonal to the optical axis.

According to an embodiment of the invention, a maximum angle between a normal line perpendicular to a tangent passing through the sensor-side surface of the seventh lens and an optical axis may have different angles in the first direction and the second direction orthogonal to the optical axis.

According to an embodiment of the invention, the first lens has a positive refractive power and has a meniscus shape convex toward the object side on the optical axis, and the second and third lenses may have refractive powers opposite to each other and may each have a meniscus shape convex toward the object side on the optical axis.

According to an embodiment of the invention, the fourth lens has positive refractive power, the fifth lens has negative refractive power, and a sum of center thicknesses of the fourth and fifth lenses may be less than a center distance between the second and third lenses.

According to an embodiment of the invention, the sixth lens has positive refractive power, has the object-side surface having a convex shape and the sensor-side surface having a concave shape on the optical axis, and the seventh lens has negative refractive power, and may have the object-side surface having a convex shape and the sensor-side surface having a concave shape on the optical axis.

An optical system according to an embodiment of the invention includes first to seventh lenses arranged along an optical axis from an object side to a sensor side, wherein the first lens has a convex object-side surface, and at least one of an object-side surface and a sensor-side surface of the sixth lens has a freeform surface, each of an object-side surface and a sensor-side surface of the seventh lens has a critical point, at least one of the object-side surface and the sensor-side surface of the seventh lens has a freeform surface shape in which a lens surface orthogonal to the optical axis in a first direction and a lens surface orthogonal to the optical axis in a second direction are asymmetrical, and Equation satisfies: 0≤JEFLX-EFLY|≤0.1, where EFLX may be an effective focal length in the first direction and EFLY may be an effective focal length in the second direction.

According to an embodiment of the invention, the sensor-side surface of the sixth lens is a freeform surface having a critical point, and Equation satisfies: 50<Inf62*L6S2_Max_slope<120, where Inf62 is an average value of distances from the optical axis to the critical points in first and second directions of the sensor-side surface of the sixth lens and L6S2_Max_slope may be the maximum angle between the optical axis and a normal line perpendicular to a tangent passing through an arbitrary point on the sensor-side surface of the sixth lens.

According to an embodiment of the invention, the sensor-side surface of the seventh lens is a freeform surface having the critical point and the following Equation satisfies: 30<Inf72*L7S2_Max_slope<110, where Inf72 is an average value of distances from the optical axis to the critical points in the first and second directions of the sensor-side surface of the seventh lens and L7S2_Max_slope may be the maximum angle between the optical axis and a normal line perpendicular to a tangent passing through an arbitrary point on the sensor-side surface of the seventh lens.

According to an embodiment of the invention, the EFLX and EFLY may have different values.

According to an embodiment of the invention, the sensor-side surface of the seventh lens has a freeform surface, and the sensor-side surface of the seventh lens may have a different distance from the optical axis to the critical point in the first direction and a distance to the critical point in the second direction.

According to an embodiment of the invention, the center distance between the sixth lens and the seventh lens is the maximum among the center distances between the first to seventh lenses, and the center thickness of the second lens may be the maximum of the center thickness of the first to seventh lenses.

According to an embodiment of the invention, the average distance from the optical axis to the critical points in the first and second directions of the object-side surface of the seventh lens is Inf71, and the average distance from the optical axis to the critical point in the first and second directions of the sensor-side surface of the seventh lens is Inf72, and the following Equation satisfies:

$$0.2 < Inf 71 / Inf 72 < 1$$

The Inf71 and the Inf72 are different from each other,

The following Equation satisfies: 0.4<TTL/(Imgh*2)<0.7

(Total track length (TTL) is a distance in the optical axis from an apex of the object-side surface of the first lens to an image surface of the image sensor, and ImgH is ½ of the maximum diagonal length of the image sensor).

An optical system according to an embodiment of the invention includes a first lens group having three or less lenses on an object side; and a second lens group having four or less lenses on the sensor side of the first lens group, wherein the first lens group has a positive (+) refractive power on an optical axis, the second lens group has a negative (−) refractive power on an optical axis, the number of lenses of the second lens group is less than twice that of the number of lenses of the first lens group, a lens closest to the second lens group among the lens surfaces of the first and second lens groups has the smallest effective diameter, a last lens closest to the image sensor among the lens surfaces of the first and second lens groups has the largest effective diameter, a sensor-side surface closest to the second lens group in the first lens group has a concave shape, an object-side surface closest to the first lens group in the second lens groups has a concave shape, a sensor-side surface of the last lens closest to the image sensor in the first and second lens groups has a freeform shape with a critical point, the sensor side surface closest to the image sensor has a lens surface orthogonal to the optical axis in a first direction and a lens surface orthogonal to the optical axis in a second direction and has an asymmetric freeform surface, the freeform surface may have symmetrical lens surfaces on both sides of the first direction with respect to the optical axis and may have symmetrical lens surfaces on both sides of the second direction.

According to an embodiment of the invention, a focal length of the second lens group in the first direction and a focal length in the second direction may be different from each other.

According to an embodiment of the invention, an optical system that satisfies the following equation:

0.4<TTL/(Imgh*2)<0.7 (TTL is a distance in the optical axis from an apex of the object-side surface of the first lens to an image surface of the image sensor, and ImgH is ½ of the maximum diagonal length of the image sensor).

According to an embodiment of the invention, the first lens group includes first to third lenses disposed along the optical axis in a direction from the object side to the sensor side, and the second lens group fourth to seventh lenses disposed along the optical axis in a direction from the object side to the sensor side, each of the object-side surface and the sensor-side surface of the sixth lens is a freeform surface having a critical point, and the object-side surface of the seventh lens may have a freeform surface having a critical point.

A camera module according to an embodiment of the invention includes an image sensor; and a filter between the image sensor and the last lens of the optical system, wherein the optical system includes an optical system disclosed above and satisfies the following equations:

$$\begin{matrix}0.5 < F / TTL < 1.2 \\ 0 < ( F / TTL ) / nL < 0.3\end{matrix}$$

(F is an average of the total focal lengths in two directions orthogonal to the optical axis of the optical system, TTL (Total track length) is a distance on the optical axis from the apex of the object-side surface of the first lens to the top surface of the sensor, and, nL is a total number of lenses).

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the FOV.

The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment(s) of the invention.

FIG. 2 is an explanatory diagram illustrating a relationship between an image sensor, an n-th lens, and an n-1-th lens in a first direction Y of the optical system of FIG. 1.

FIG. 3 is an explanatory diagram illustrating the relationship between an image sensor, an n-th lens, and an n-1-th lens in a second direction X of the optical system of FIG. 1.

FIG. 4 is a plan view viewed from the n−1th lens of the optical system of FIG. 1.

FIG. 5 is a table showing lens data according to the first embodiment having the optical system of FIG. 1.

FIGS. 6 and 7 are examples of aspherical surface coefficients of lenses according to the first embodiment of the invention.

FIG. 8 is a table showing center thicknesses of first to fifth lenses and distances between adjacent lenses based on a direction perpendicular to an optical axis in an optical system according to a first embodiment of the invention.

FIG. 9 is a table showing center thicknesses of sixth and seventh lenses and center distances between adjacent lenses based on a direction orthogonal to an optical axis in an optical system according to a first embodiment of the invention.

FIG. 10 is a table showing Sag (sagittal) height data of the n-th lens and the n−1-th lens in the optical system according to the first embodiment of the invention.

FIG. 11 is a table showing lens data according to a second embodiment having the optical system of FIG. 1.

FIGS. 12 and 13 are examples of aspherical surface coefficients of lenses according to the first embodiment of the invention.

FIG. 14 is a table showing center thicknesses of first to fifth lenses and distances between adjacent lenses based on a direction perpendicular to an optical axis in an optical system according to a first embodiment of the invention.

FIG. 15 is a table showing center thicknesses of sixth and seventh lenses and center distances between adjacent lenses based on a height direction orthogonal to an optical axis in an optical system according to a first embodiment of the invention.

FIG. 16 is a table showing Sag (sagittal) height data of the n-th lens and the n−1-th lens in the optical system according to the first embodiment of the invention.

FIG. 17 is a view comparing thicknesses according to the height and position (0 degree, 30 degree, 45 degree, 60 degree, 90 degree) of the seventh lens of the optical system according to the first and second embodiments of the invention.

FIG. 18 is a graph showing Sag (sagittal) height data according to the height and position (0 degree, 30 degree, 45 degree, 60 degree, 90 degree) of the sensor-side surface of the seventh lens of the optical system according to the first and second embodiments of the invention.

FIG. 19 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to +0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

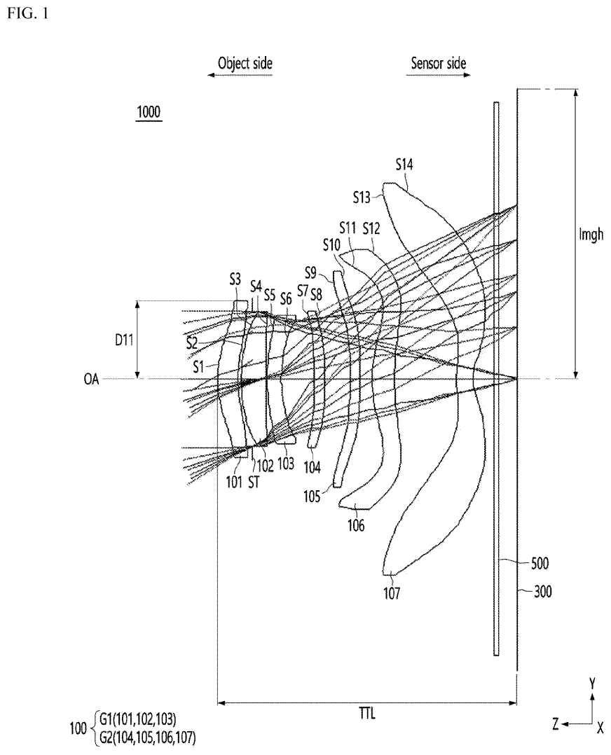

FIG. 1 is a diagram showing an optical system 1000 and a camera module having the same according to first and second embodiments of the invention.

Referring to FIG. 1, an optical system 1000 may include a plurality of lens groups G1 and G2. In detail, each of the plurality of lens groups G1 and G2 includes at least one lens. For example, the optical system 1000 may include a first lens group G1 and a second lens group G2 sequentially disposed along the optical axis OA toward the image sensor 300 from the object side. The number of lenses of the second lens group G2 in the plurality of lens groups G1 and G2 may be greater than the number of lenses of the first lens group G1, for example, more than 1 time and less than t times the number of lenses of the first lens group G1.

The first lens group G1 may include at least one lens. The first lens group G1 may include three or less lenses. For example, the first lens group G1 may include three lenses. The second lens group G2 may include at least two or more lenses. The second lens group G2 may have more lenses than the number of lenses of the first lens group G1, and may include 6 or less lenses or 5 lenses or less. The number of lenses of the second lens group G2 may have a difference of 1 or more and 2 or less compared to the number of lenses of the first lens group G1. For example, the second lens group G2 may include four lenses.

The first lens group G1 refracts the light incident through the object side to converge, and the second lens group G2 converts the light emitted through the first lens group G1 so as to diffuse to the periphery of the image sensor 300.

In the optical system 1000, the total track length (TTL) may be less than 70% of the diagonal length of the image sensor 300, and may be, for example, in the range of 40% to 60% or 40% to 55%. The TTL is the distance along the optical axis OA from the object-side surface of the first lens closest to the object side to the image surface of the image sensor, and the diagonal length of the image sensor 300 may be the maximum diagonal length of the image sensor 300, and may be twice the distance Imgh from the optical axis OA to the end of the diagonal. Accordingly, it is possible to provide a slim optical system and a camera module having the same. The total number of lenses of the first and second lens groups G1 and G2 is 6 to 8.

The first lens group G1 and the second lens group G2 in the optical axis OA may have a set interval. The optical axis distance between the first lens group G1 and the second lens group G2 in the optical axis OA is a separation distance on the optical axis OA, and may be an optical axis distance between the sensor-side surface of the lens closest to the sensor side among the lenses in the first lens group G1 and the object-side surface of the lens closest to the object side among the lenses in the second lens group G2. The optical axis distance between the first lens group G1 and the second lens group G2 is greater than the maximum center thickness of the lenses of the first lens group G1, and may be greater than the maximum center thickness among the lenses of the second lens group G2.

The optical axis distance between the first lens group G1 and the second lens group G2 is smaller than the optical axis distance of the first lens group G1 and maybe 41% or more of the optical axis distance of the first lens group G1, for example, in the range of 41% to 61% or 46% to 56% of the optical axis distance of the first lens group G1. Here, the optical axis distance of the first lens group G1 is a distance in the optical axis between the object-side surface of the lens closest to the object side of the first lens group G1 and the sensor-side surface of the lens closest to the sensor side.

The optical axis distance between the first lens group G1 and the second lens group G2 may be 30% or less of the optical axis distance of the second lens group G2, for example, in a range of 10% to 30%. The optical axis distance of the second lens group G2 is a distance in the optical axis between the object-side surface of the lens closest to the object side of the second lens group G2 and the sensor-side surface of the lens closest to the sensor side.

A lens having a minimum average effective diameter in the first lens group G1 may be a lens closest to the second lens group G2. A lens having a minimum average effective diameter in the second lens group G2 may be a lens closest to the first lens group G1. A lens having the smallest effective diameter within the optical system 1000 may be the last lens of the first lens group G1.

The lens having the smallest effective diameter in the optical system 1000 may be any one lens adjacent to the optical axis distance between the first lens group G1 and the second lens group G2. Here, the average effective diameter is an average value of an object-side effective diameter and a sensor-side effective diameter of the lens. Accordingly, the optical system 1000 may have good optical performance not only at the center portion of the FOV (field of view) but also at the periphery portion, and chromatic aberration and distortion aberration may be improved. A size of a lens having a minimum effective diameter in the first lens group G1 may be smaller than a size of a lens having a minimum effective diameter in the second lens group G2.

The optical system 1000 may include eight or less lenses or seven lenses or less.

The lens closest to the object side among the lenses of the first lens group G1 has positive (+) refractive power, and the lens closest to the sensor side among the lenses of the second lens group G2 may have negative (−) refractive power. In the optical system 1000, the number of lenses having positive (+) refractive power may be greater than the number of lenses having negative (−) refractive power. In the first lens group G1, the number of lenses having positive (+) refractive power may be greater than the number of lenses having negative (−) refractive power. In the second lens group G2, the number of lenses having positive (+) refractive power and the number of lenses having negative (−) refractive power may be the same.

Each of the plurality of lenses 100 may include an effective region and a non-effective region. The effective region is a region through which light incident on each of the lenses 100 passes, and may extend to the end of the effective diameter. That is, the effective region may be an effective region in which the incident light is refracted to realize optical characteristics. The non-effective region may be arranged around the effective region. The non-effective region may be a region in which effective light from the plurality of lenses 100 is not incident. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS).

The optical system 1000 may include an optical filter 500. The optical filter 500 may be disposed between the second lens group G2 and the image sensor 300. The optical filter 500 may be disposed between a lens closest to a sensor side among the plurality of lenses 100 and the image sensor 300. For example, when the optical system 100 is the last lens, the optical filter 500 may be disposed between the last lens and the image sensor 300.

The optical filter 500 may include at least one of an infrared filter and an optical filter of a cover glass. The filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 may transmit visible light and reflect infrared light.

The optical system 1000 according to the embodiment may include an aperture stop ST. The aperture stop ST may control the amount of light incident on the optical system 1000. The aperture stop ST may be disposed around the lenses of the first lens group G1. For example, the aperture stop ST may be disposed around an object-side surface or a sensor-side surface of the first lens 101 closest to the object side. The aperture stop ST may be disposed between two adjacent lenses 101 and 102 among the lenses in the first lens group G1. For example, the aperture stop ST may be located around the sensor-side surface S2 of the first lens 101 closest to the object side. Alternatively, at least one lens selected from among the plurality of lenses 100 may serve as an aperture stop. In detail, an object-side surface or a sensor-side surface of one lens selected from among the lenses of the first lens group G1 may serve as an aperture stop for adjusting the amount of light.

The focal length of the first lens group G1 may have a positive value, and the focal length of the second lens group G2 may have a negative value. As an absolute value, the focal length of the second lens group G2 may be greater than that of the first lens group G1. Here, the focal length is the reciprocal of the refractive power.

The optical system 1000 according to the embodiment may further include a reflective member (not shown) for changing a path of light. The reflective member may be implemented as a prism that reflects incident light of the first lens group G1 toward the lenses. Hereinafter, an optical system according to an embodiment will be described in detail.

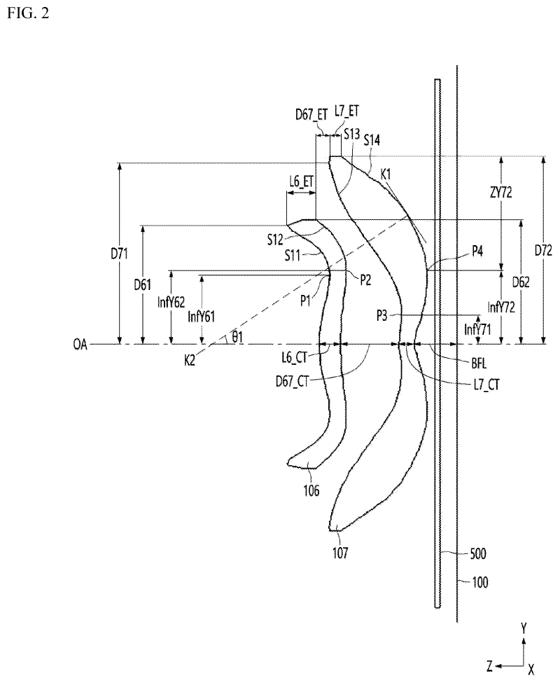

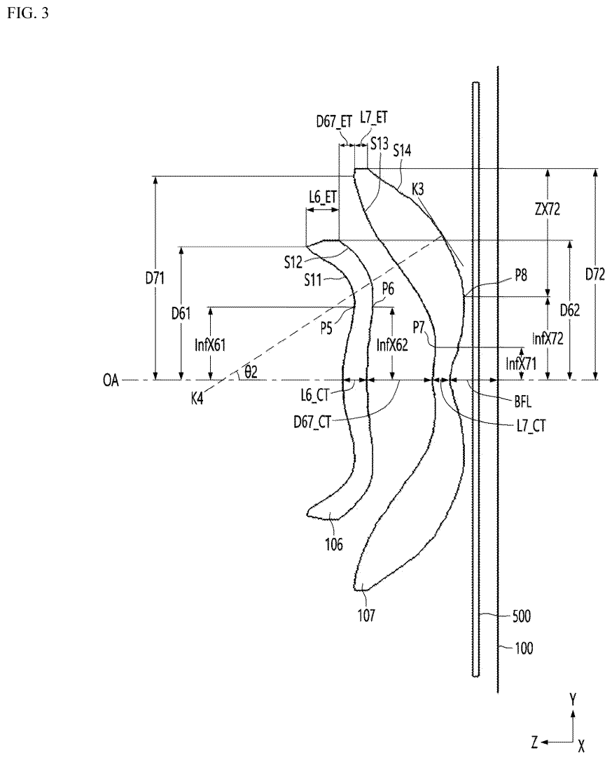

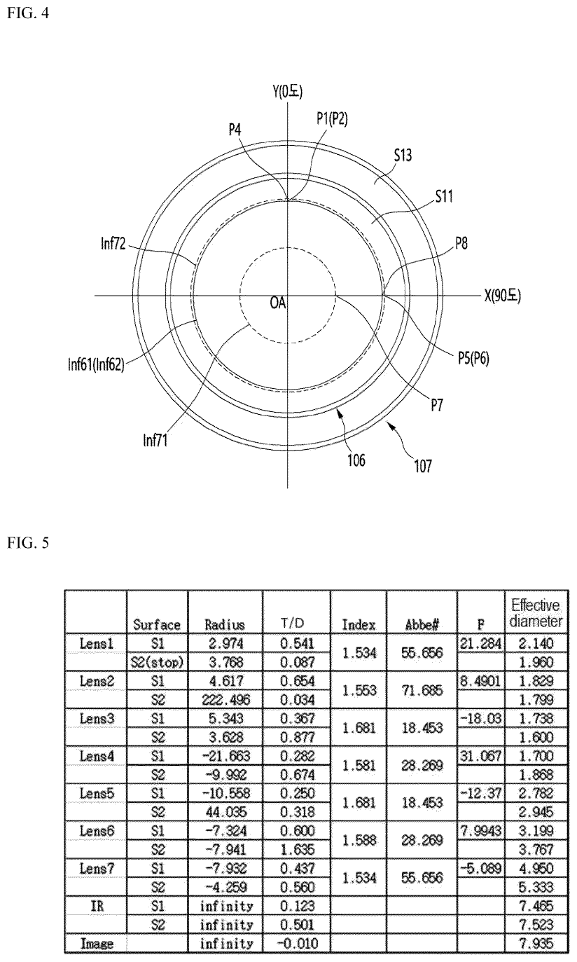

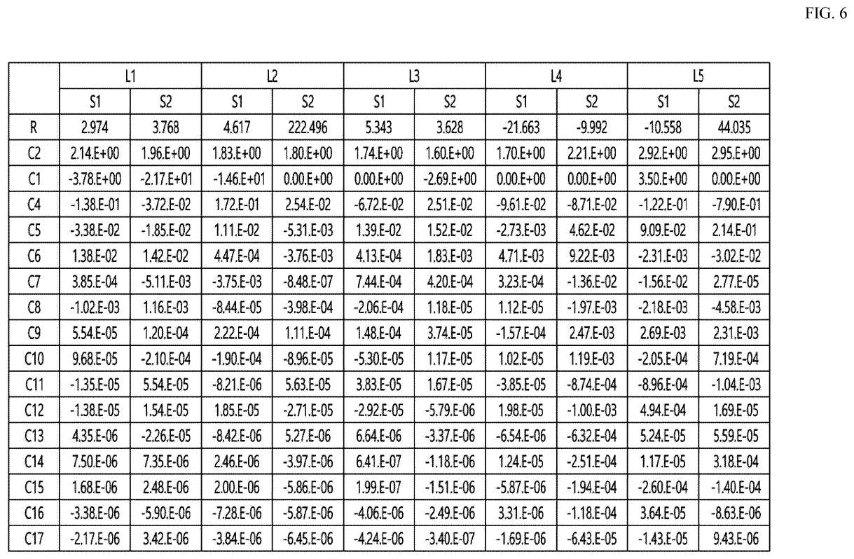

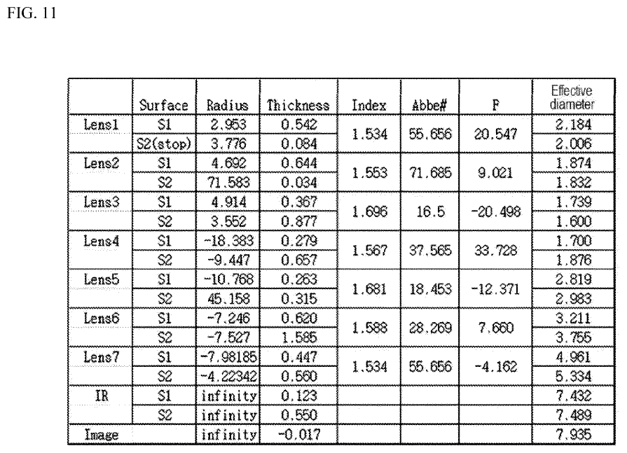

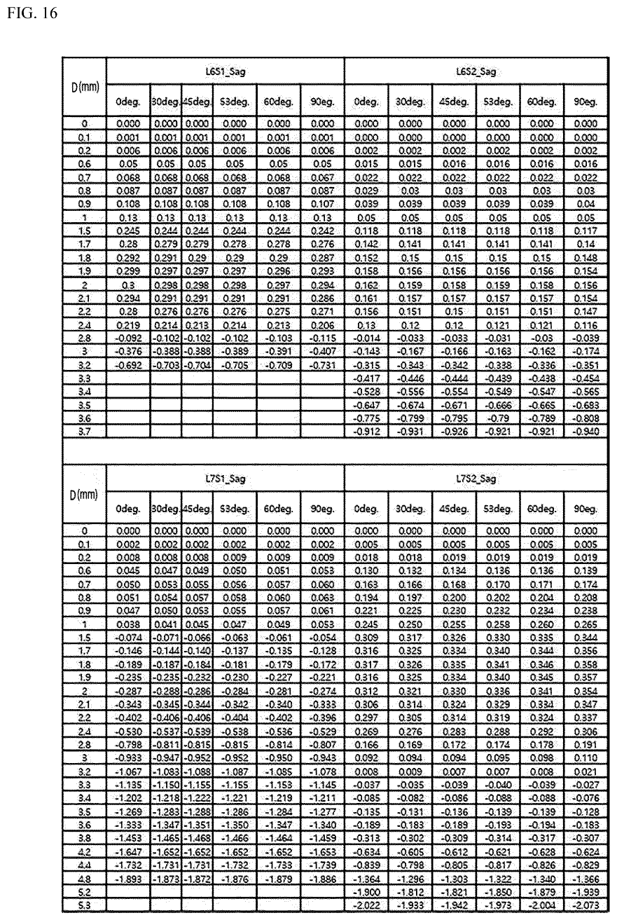

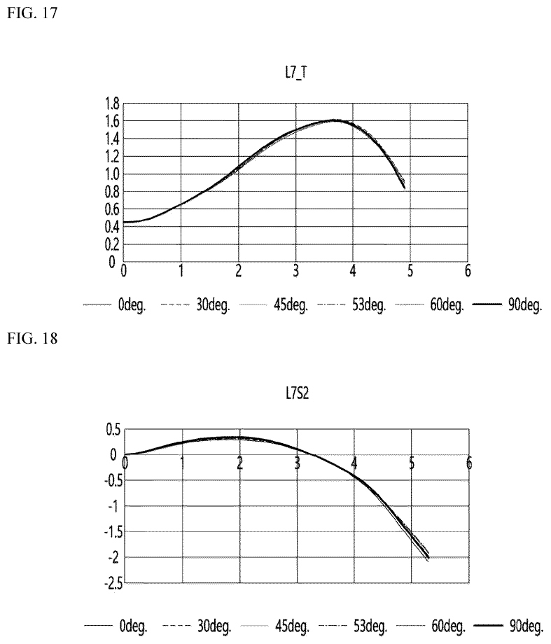

FIG. 1 is a configuration diagram of an optical system and a camera module according to an embodiment(s) of the invention, FIG. 2 is an explanatory diagram illustrating a relationship between an image sensor, an n-th lens, and an n-1-th lens in a first direction Y of the optical system of FIG. 1, FIG. 3 is an explanatory diagram illustrating the relationship between an image sensor, an n-th lens, and an n-1-th lens in a second direction X of the optical system of FIG. 1, and FIG. 4 is a plan view viewed from the n−1th lens of the optical system of FIG. 1. FIGS. 5 to 10 are views showing lens data of the optical system according to the first embodiment, FIGS. 11 to 16 are views showing lens data of the optical system according to the second embodiment, FIG. 17 is a view comparing the thickness (L7_T) of the seventh lens in each direction (0 degree to 90 degrees) from the optical axis to the end of the effective region with respect to the thickness (L7_T) of the seventh lens in the first and second embodiments, and FIG. 18 is a diagram comparing the SAG heights in each direction from the optical axis to the end of the effective region for the sensor-side surface (L7S2) of the seventh lens in the first and second embodiments.

Referring to FIGS. 1 to 4, 5 and 11, an optical system 1000 according to an embodiment includes a plurality of lenses 100, and the plurality of lenses 100 may include first lenses 101 to seventh lenses 107. The first to seventh lenses 101 to 107 may be sequentially aligned along the optical axis OA of the optical system 1000, and light corresponding to object information may receive and may be incident on the image sensor 300.

The first lens 101 may have positive (+) refractive power along the optical axis OA. The first lens 101 may include a plastic or glass material. For example, the first lens 101 may be made of a plastic material.

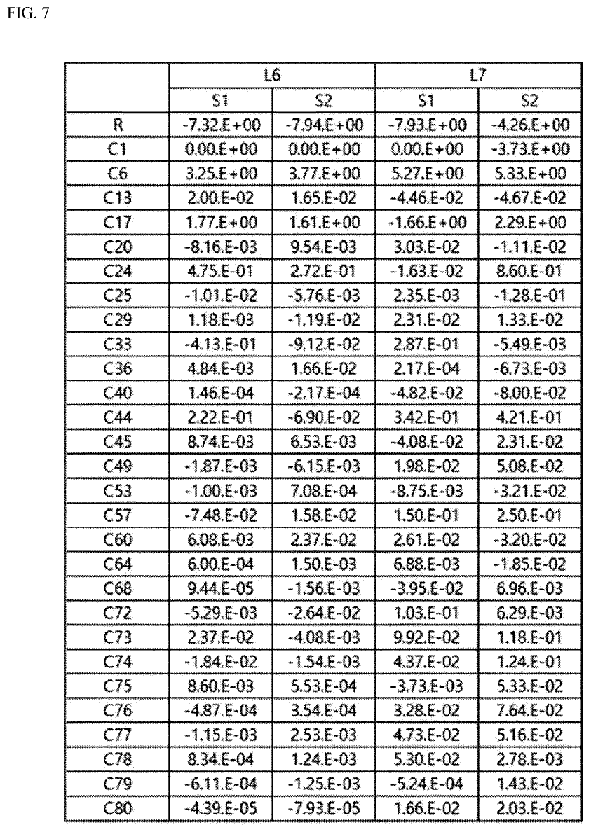

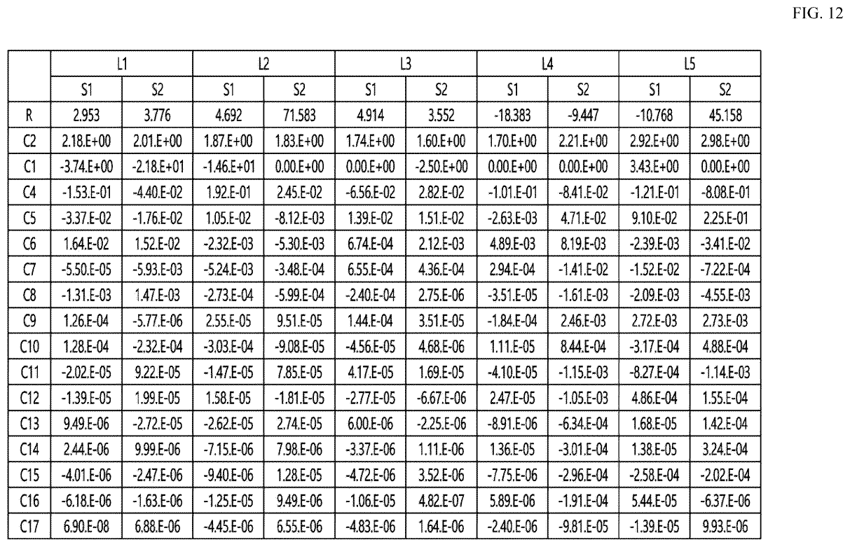

The first lens 101 may include a first surface S1 defined as an object-side surface and a second surface S2 defined as a sensor-side surface. On the optical axis OA, the first surface S1 may have a convex shape, and the second surface S2 may have a concave shape. That is, the first lens 101 may have a meniscus shape convex from the optical axis OA toward the object side. At least one of the first surface S and the second surface S2 may be an aspherical surface. For example, both the first surface S1 and the second surface S2 may be aspherical. In the first and second embodiments, aspheric coefficients of the first and second surfaces S1 and S2 are provided as shown in FIGS. 6 and 12, and may be represented by S1 and S2 of L1.

The second lens 102 may have positive (+) or negative (−) refractive power on the optical axis OA. The second lens 102 may have positive (+) refractive power. The second lens 102 may include a plastic or glass material. For example, the second lens 102 may be made of a plastic material.

The second lens 102 may include a third surface S3 defined as an object-side surface and a fourth surface S4 defined as a sensor-side surface. On the optical axis OA, the third surface S3 may have a convex shape, and the fourth surface S4 may have a concave shape. That is, the second lens 102 may have a meniscus shape convex from the optical axis OA toward the object side. Alternatively, the second lens 102 may have a shape in which both sides are convex or both sides are concave. When expressed as an absolute value, the curvature radius of the fourth surface S4 of the second lens 102 may be the largest in the optical system 1000. At least one of the third and fourth surfaces S3 and S4 may be an aspherical surface. For example, both the third surface S3 and the fourth surface S4 may be aspheric surfaces. In the first and second embodiments, the aspheric coefficients of the third and fourth surfaces S3 and S4 are provided as shown in FIGS. 6 and 12, L2 is the second lens 102, L2S1 is the third surface, and L2S2 is the fourth surface.

The third lens 103 may have positive (+) or negative (−) refractive power on the optical axis OA, and may preferably have negative (−) refractive power. The third lens 103 may include a plastic or glass material. For example, the third lens 103 may be made of a plastic material.

The third lens 103 may include a fifth surface S5 defined as an object-side surface and a sixth surface S6 defined as a sensor-side surface. On the optical axis OA, the fifth surface S5 may have a convex shape, and the sixth surface S6 may have a concave shape. That is, the third lens 103 may have a meniscus shape convex from the optical axis OA toward the object side. Alternatively, the third lens 103 may have a shape in which both sides are convex or both sides are concave on the optical axis OA. At least one of the fifth surface S5 and the sixth surface S6 may be an aspheric surface. For example, both the fifth surface S5 and the sixth surface S6 may be aspheric surfaces. In the first and second embodiments, the aspheric coefficients of the fifth and sixth surfaces S5 and S6 are provided as shown in FIGS. 6 and 12, L3 is the third lens 103, L3S1 is the fifth surface, and L3S2 is the sixth surface.

The first lens group G1 may include first to third lenses 101, 102, and 103. In the thickness in the optical axis OA among the first to third lenses 101, 102, and 103, this is, the center thickness of the lens, the second lens 102 may have the thickest thickness and the third lens 103 may have the thinnest thickness in the optical axis OA. The first to third lenses 101, 102, and 103 may have a meniscus shape convex toward the object side. Accordingly, the optical system 1000 may control incident light and may have improved aberration characteristics and resolution.

Among the first to third lenses 101, 102, and 103, the third lens 103 may have the smallest average effective diameter (CA: clear aperture) of the lenses, and the first lens 101 may have the largest effective diameter. In detail, among the first to third lenses 101, 102, and 103, the effective radius D11 of the first surface S1 may be the largest, and the effective radius of the sixth surface S6 of the third lens 103 may be the smallest. Also, the size of the effective diameter of the second lens 102 may be smaller than that of the first lens 101 and larger than the size of the effective diameter of the third lens 103. The size of the effective diameter of the third lens 103 may be the smallest among the lenses of the optical system 1000. The size of the effective diameter is an average value of the size of the effective diameter on the object-side surface of each lens and the effective diameter size on the sensor-side surface of each lens. Accordingly, the optical system 1000 may have improved chromatic aberration control characteristics, and may improve vignetting characteristics of the optical system 1000 by controlling incident light.

The refractive index of the third lens 103 may be greater than the refractive index of at least one or all of the first and second lenses 101 and 102. The refractive index of the third lens 103 may be greater than 1.6, for example, 1.65 or greater, and the refractive index of the first and second lenses 101 and 102 may be less than 1.6. The third lens 103 may have an Abbe number smaller than the Abbe numbers of at least one or both of the first and second lenses 101 and 102. For example, the Abbe number of the third lens 103 may be smaller than the Abbe numbers of the first and second lenses 101 and 102 with a difference of 20 or more. In detail, the Abbe number of the first and second lenses 101 and 102 may be 30 or more greater than the Abbe number of the third lens 103. Accordingly, the optical system 1000 may have improved chromatic aberration control characteristics.

When the curvature radius on the optical axis OA is expressed as an absolute value, the curvature radius of the fourth surface S4 of the second lens 102 may be the largest among the first to third lenses 101, 102, and 103. The curvature radius of the first surface S1 of the first lens 101 may be the smallest. In the first lens group G1, a difference between a lens surface having a maximum curvature radius and a lens surface having a minimum curvature radius may be 50 times or more.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be made of a plastic material.

The fourth lens 104 may include a seventh surface S7 defined as an object-side surface and an eighth surface S8 defined as a sensor-side surface. On the optical axis OA, the seventh surface S7 may have a concave shape, and the eighth surface S8 may have a convex shape. That is, the fourth lens 104 may have a meniscus shape convex from the optical axis OA toward the sensor. Alternatively, the seventh surface S7 may have a convex shape along the optical axis OA, and the eighth surface S8 may have a convex shape on the optical axis OA. That is, the fourth lens 104 may have a convex shape on both sides of the optical axis OA. Alternatively, the seventh surface S7 may have a convex shape on the optical axis OA, and the eighth surface S8 may have a concave shape on the optical axis OA. That is, the fourth lens 104 may have a meniscus shape convex from the optical axis OA toward the object side. Alternatively, the fourth lens 104 may have a concave shape on both sides of the optical axis OA. The seventh and eighth surfaces S7 and S8 of the fourth lens 104 may be provided from the optical axis OA to the end of the effective region without a critical point. At least one of the seventh surface S7 and the eighth surface S8 may be an aspherical surface. For example, both the seventh surface S7 and the eighth surface S8 may be aspheric surfaces. In the first and second embodiments, the aspheric coefficients of the seventh and eighth surfaces S7 and S8 are provided as shown in FIGS. 6 and 12, LA is the fourth lens 104, L4S1 is the seventh surface, and L4S2 is the eighth surface.

The refractive index of the fourth lens 104 may be smaller than the refractive index of the third lens 103. The Abbe number of the fourth lens 104 may be greater than the Abbe number of the third lens 103, greater than the Abbe number of the fifth lens 105, and smaller than the Abbe number of the first lens 101. The focal length of the fourth lens 104 may be greater than the focal lengths of the first to third lenses 101, 102, and 103. Accordingly, the optical system 1000 may have improved chromatic aberration control characteristics.

The fifth lens 105 may have positive (+) or negative (−) refractive power on the optical axis OA. The fifth lens 105 may have negative (−) refractive power. The fifth lens 105 may include a plastic or glass material. For example, the fifth lens 105 may be made of a plastic material.

The fifth lens 105 may include a ninth surface S9 defined as an object-side surface and a tenth surface S10 defined as a sensor-side surface. The ninth surface S9 may have a concave shape on the optical axis OA, and the tenth surface S10 may have a concave shape on the optical axis OA. That is, the fifth lens 105 may have a concave shape on both sides of the optical axis OA. Alternatively, the fifth lens 106 may have a meniscus shape convex toward the sensor. The ninth and tenth surfaces S9 and S10 of the fifth lens 105 may be provided from the optical axis OA to the end of the effective region without a critical point. When the curvature radius on the optical axis OA is expressed as an absolute value, the curvature radius of the tenth surface S10 may be twice or more than the curvature radius of the ninth surface S9. The refractive index of the fifth lens 105 may be greater than 1.6, for example, 1.65 or greater, and may be greater than the refractive indices of the fourth, sixth and seventh lenses 104, 106 and 107. At least one of the ninth surface S9 and the tenth surface S10 may be an aspherical surface. For example, both the ninth surface S9 and the tenth surface S10 may be aspheric surfaces. In the first and second embodiments, the aspheric coefficients of the ninth and tenth surfaces S9 and S10 are provided as shown in FIGS. 6 and 12, L5 is the fifth lens 105, L5S1 is the ninth surface, and L5S2 is the tenth surface.

The sixth lens 106 may have positive (+) or negative (−) refractive power on the optical axis OA. The sixth lens 106 may have positive (+) refractive power. The sixth lens 106 may include a plastic or glass material. For example, the sixth lens 106 may be made of a plastic material.

The sixth lens 106 may include an eleventh surface S11 defined as an object-side surface and a twelfth surface S12 defined as a sensor-side surface. The eleventh surface S11 may have a convex shape on the optical axis OA, and the twelfth surface S12 may have a concave shape on the optical axis OA. That is, the sixth lens 106 may have a meniscus shape convex from the optical axis OA toward the object side. Alternatively, the eleventh surface S11 may have a concave shape on the optical axis OA, and the twelfth surface S12 may have a convex shape on the optical axis OA. That is, the sixth lens 106 may have a meniscus shape convex toward the sensor. At least one or both of the eleventh surface S11 and the twelfth surface S12 may be freeform surfaces. In the first and second embodiments, the polynomial coefficients C1-C80 representing the freeform surfaces of the eleventh and twelfth surfaces S11 and S12 may be obtained according to the first and second embodiments as shown in FIGS. 7, and L6 is the sixth lens 106, L6S1 is the eleventh surface, and L6S2 is the twelfth surface.

At least one or both of the eleventh surface S11 and the twelfth surface S12 of the sixth lens 106 may have an asymmetric shape in the lens surface in the first direction Y and the second direction X perpendicular to the optical axis OA. At least one or both of the eleventh surface S1l and the twelfth surface S12 are symmetrical with respect to both sides of the first direction Y orthogonal to the optical axis OA, and are symmetrical with respect to both sides of the second direction X. The sixth lens 106 may have different thicknesses within the same radius along the first direction Y and the second direction X orthogonal to the optical axis OA.

As shown in FIGS. 2 to 4, positions of critical points P1 and P5 of the eleventh surface S11 of the sixth lens 106 may be equal or different distances InfX61 and InfY61 in the first direction Y and the second direction X orthogonal to the optical axis OA. Positions of the critical points P2 and P6 of the twelfth surface S12 of the sixth lens 106 may be equal or different distances InfX62 and InfY62 in the first direction Y and the second direction X orthogonal to the optical axis OA.

In FIG. 4, the average values Inf61 and Inf62 of the critical points are lines showing the average positions of the critical points P1, P2, P5, and P6 in the eleventh surface S11 and the twelfth surface S12, and the optical axis OA and may be a circular shape having the same radius or different radii according to orthogonal directions.

As shown in FIGS. 2, 3, 4, 10, and 16, the critical points P2 and P6 of the twelfth surface S12 may be located at the same distance at angles (0 degrees, 30 degrees, 35 degrees, 53 degrees, 60 degrees, 90 degrees) according to a radius of virtual circle, or at least one of them may be positioned at different distances. Here, an angle θ passing through the optical axis OA represents a first direction X orthogonal to the optical axis OA, and an angle 90 represents a second direction Y orthogonal to the optical axis OA and the first direction X, and the angles 30 degrees, 35 degrees, 53 degrees, and 60 degrees are angles in different directions orthogonal to the optical axis OA from the first direction X to the second direction Y. For example, the critical points P2 and P6 of the twelfth surface S12 may have the same or different distances InfX62 and InfY62 in the first direction X (Angle 0) and the second direction Y (Angle 90). Further, a distance InfX62 from the optical axis OA to the critical point P2 in the first direction X (Angle 0) and a distance to a critical point at any one position between 30 degrees and 60 degrees may be different from each other. A distance InfY62 from the optical axis OA to the critical point P6 in the second direction Y and a distance to a critical point at any one of 30 degrees and 60 degrees may be the same as or different from each other.

The eleventh surface S11 of the sixth lens 106 may have at least one critical point from the optical axis OA to the end of the effective radius, and the twelfth surface S12 may have at least one critical point from the optical axis OA to the end of the effective radius. The critical points P1 and P5 of the eleventh surface S11 may be located at distances InfX61 and InfY61 of 54% or more of the effective radius D61, which is the distance from the optical axis OA to the end of the effective radius, for example, in the range of 54% to 74% or in the range of 59% to 69%. The critical points P2 and P6 of the twelfth surface S12 may be located at distances InfX62 and InfY62 of 44% or more of the effective radius D62 with respect to the optical axis OA, for example, in the range of 44% to 64% or 49% to 59%.

The positions of the critical points P2 and P6 of the twelfth surface S12 of the sixth lens 106 and the positions of the critical points P1 and P5 of the eleventh surface S11 may be located in the range of 1.7 mm to 2.3 mm with respect to the optical axis OA. The critical point P2 in the first direction X of the twelfth surface S12 is disposed at the same distance from the optical axis OA, or a distance difference between them of 0.2 mm or less than a distance of the critical point P6 in the second direction Y. Accordingly, the twelfth surface S12 may diffuse the light incident through the eleventh surface S11. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases. It is preferable that the positions of the critical points P1, P2, P5, and P6 of the sixth lens 106 are disposed at positions satisfying the aforementioned range in consideration of the optical characteristics of the optical system 1000. In detail, the position of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

The seventh lens 107 may have negative (−) refractive power on the optical axis OA. The seventh lens 107 may include a plastic or glass material. For example, the seventh lens 107 may be made of a plastic material. The seventh lens 107 may be the closest lens to the sensor side or the last lens in the optical system 1000.

The seventh lens 107 may include a thirteenth surface S13 defined as an object-side surface and a fourteenth surface S14 defined as a sensor-side surface. The thirteenth surface S13 may have a convex shape on the optical axis OA, and the fourteenth surface S14 may have a concave shape on the optical axis OA. That is, the seventh lens 107 may have a meniscus shape convex from the optical axis OA toward the object side. Unlike this, the thirteenth surface S13 of the seventh lens 107 may be concave on the optical axis OA, and the fourteenth surface S14 may be concave or convex.

The thirteenth surface S13 may be a freeform surface. The fourteenth surface S14 may be a freeform surface. The freeform surface coefficients of the thirteenth and fourteenth surfaces S13 and S14 are provided as shown in FIGS. 7 and 13, L7 is the seventh lens 107, S1 of L7 is the thirteenth surface, and S2 is the fourteenth surface. Further, the polynomial coefficients C1-C80 representing the freeform surfaces of L7S1 and L7S2 may be obtained according to the first and second embodiments, as shown in FIGS. 7 and 13. Accordingly, the seventh lens 107 may be a freeform lens.

As shown in FIGS. 2 to 4, at least one or both of the thirteenth surface S13 and the fourteenth surface S14 of the seventh lens 107 may be provided as a freeform surface. For example, the thirteen and fourteenth surfaces S13 and S14 of the seventh lens 107 are freeform surfaces and have a symmetrical shape (+X, −X) with respect to the optical axis OA in the first direction X orthogonal to the optical axis OA, and may have a symmetrical shape (+Y, −Y) in the second direction Y orthogonal to the optical axis OA. That is, as shown in FIGS. 2 and 3, the lens surfaces of the +Y and −Y directions are symmetrical to both sides of the second direction Y with respect to the X-Z plane or the optical axis OA, and lens surfaces of +X and −X directions are symmetrical to both sides of the first direction X based on the Y-Z plane or the optical axis OA. Here, the Z-axis direction is the optical axis direction. The lens surfaces of the thirteen and fourteenth surfaces S13 and S14 in the first direction X and the second direction Y may be orthogonal to each other and may have an asymmetrical shape with respect to the optical axis OA.

The thirteenth surface S13 and the fourteenth surface S14 of the seventh lens 107 may have at least one critical point from the optical axis OA to the end of the effective region. The critical points P3 and P7 of the thirteenth surface S13 may be located the first and second distances InfX71 and InfY71 less than or equal to 26% of the effective radius D71, which is the distance from the optical axis OA to the end of the effective radius, for example, may be in the range of 6% to 26% or in the range of 11% to 21%.

The first and second distances InfX71 and InfY71 to the critical points P3 and P7 of the thirteenth surface S13 of the seventh lens 107 may be located at the same distance or have a difference of 0.1 mm or less in directions X and Y from the optical axis OA of the thirteenth surface S13. The first and second distances InfX71 and InfY71 may be disposed within a range of 1.1 mm or less, for example, in the range of 0.6 mm to 1.1 mm, from the optical axis OA.

The critical points P4 and P8 of the fourteenth surface S14 of the seventh lens 107 may be located at the third and fourth distance InfX72 and InfY72 of 43% or less of the effective radius D72 based on the optical axis OA in the first and second directions X and Y, for example, in a range of 23% to 43% or a range of 28% to 38%. The positions of the critical points P4 and P8 of the fourteenth surface S14 may be farther from the optical axis OA than the critical points P3 and P7 of the thirteenth surface S13. For example, the critical points P4 and P8 may be spaced apart from the critical points P3 and P7 toward the edge by 0.5 mm or more, for example, in a range of 0.5 mm to 1.5 mm. Accordingly, the fourteenth surface S14 may diffuse the light incident through the thirteenth surface S13.

The third distance InfX72 is a distance from the optical axis OA of the fourteenth surface S14 to the critical point P4 in the first direction X, and the fourth distance InfY72 is a distance from the optical axis OA of the fourteenth surface S14 to the critical point P8 in the second direction Y, and may satisfy: InfX72<InfY72. A difference between the third and fourth distances InfX72 and InfY72 may be 0.2 mm or less. The third and fourth distances InfX72 and InfY72 may be disposed within a range of 1.6 mm or more, for example, in the range of 1.6 mm to 2.2 mm, from the optical axis OA.

Effective radii D71 of the thirteenth surface S13 in the first and second directions X and Y may be the same. Effective radii D72 of the fourteenth surface S14 in the first and second directions X and Y may be the same. In FIG. 4, the average value of the critical point Inf71 and Inf72 represent the average distances of the critical points P3, P4, P7, and P8 in the thirteenth surface S13 and the fourteenth surface S14, and may have circular shapes with different radii.

As in the first and second embodiments of FIGS. 2, 3, and 4 and FIGS. 10 and 16, the critical points of the thirteenth surface S13 may be located at the same distance or at least one different distance from each other according to an angle (0 degree, 30 degree, 35 degrees, 53 degrees, 60 degrees, 90 degrees) in the radius of an virtual circle. For example, the critical points P3 and P7 of the thirteenth surface S13 may be the same at the distances in the first direction X (Angle 0) and the second direction Y (Angle 90), and at a position of 30 degrees to 60 degrees different from in the first direction X (Angle 0).

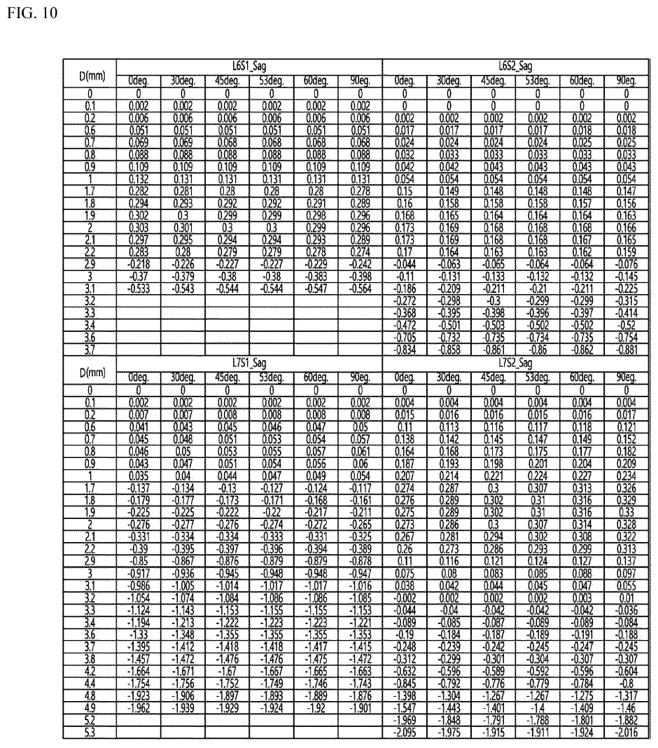

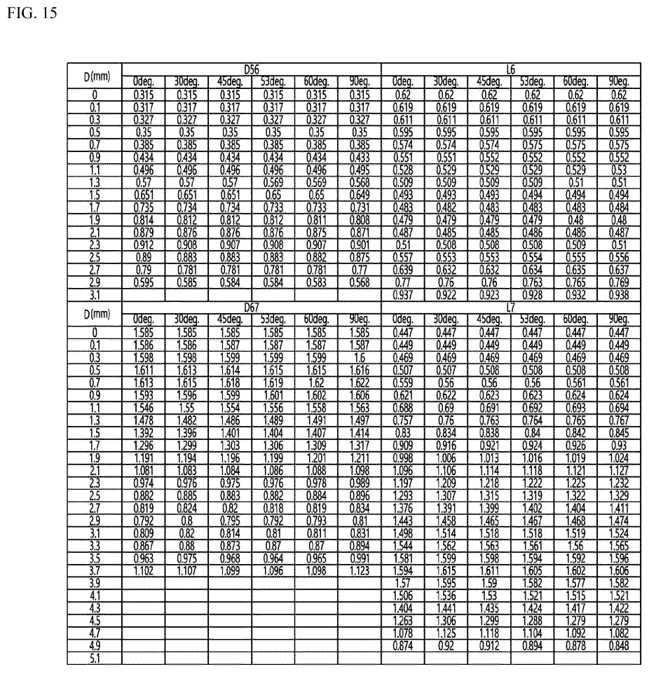

As in the first embodiment of FIG. 10, the critical point of the fourteenth surface S14 may have different distances at least one of angles (0 degree, 30 degree, 35 degree, 53 degree, 60 degree, 90 degree) according to the radius of the virtual circle. For example, in the fourteenth surface S14, the distance InfX72 from the optical axis OA to the critical point in the first direction X (0 degrees) and the distance from the optical axis OA to the critical point at 30 degrees may be equal to each other. The distances InfY72 from the optical axis OA to critical points in the second direction Y (90 degrees) on the fourteenth surface S14 may be the same distances from the optical axis OA to critical points at 35 degrees, 53 degrees, and 60 degrees, respectively. Distances from the optical axis OA to critical points of angles (0 degrees and 30 degrees) may be different from each other. Accordingly, the critical points P4 and P8 in the first direction X and the second direction Y may be located at different distances from each other in the optical axis OA, and may satisfy, for example, InfX72<InfY72. As in the second embodiment of FIG. 16, the critical points of the fourteenth surface S14 may be located at the same distance or may differ from each other in 0.2 mm or less at angles (0 degrees, 30 degrees, 35 degrees, 53 degrees, 60 degrees, 90 degrees) according to the radius of a virtual circle.

It is preferable that the positions of the critical points P3, P4, P7, and P8 of the seventh lens 107 are disposed at positions satisfying the aforementioned range in consideration of the optical characteristics of the optical system 1000. In detail, the position of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

Here, the curvature radius of the object-side surface and the sensor-side surface of the sixth and seventh lenses 106 and 107 may have a shape opposite to that of the lens surface of the sixth and seventh lenses due to freeform surface characteristics. For example, as shown in FIGS. 5 and 11, the curvature radii of S1 and S2 of the sixth and seventh lenses 106 and 107 both have negative values, but as shown in FIGS. 1 to 3, the eleventh surface S11 of the sixth lens 106 may be convex, the twelfth surface S12 may be concave, the thirteenth surface S13 of the seventh lens 1070 may be convex, and the fourteenth surface S14 may be concave.

As shown in FIGS. 2 and 3, the normal lines K2 and K4, which is a straight perpendicular to the tangent lines K1 and K3 of the first and second directions X and Y passing through any point on the sensor-side surface S14 of the seventh lens 107, may have predetermined angles θ1 and θ2 from the optical axis OA, and the angles θ1 and θ2 in the first and second directions X and Y may be different from each other, and may be less than 70 degrees maximum, for example in the range of 5 degrees to 69 degrees or in the range of 30 degrees to 65 degrees. Accordingly, since the optical axis or paraxial region of the fourteenth surface S14 has a minimum Sag value, a slim optical system may be provided.

As shown in FIGS. 2 and 3, a back focal length (BFL) is an optical axis distance from the image sensor 300 to the seventh lens 107, which is the last lens. That is, BFL is a distance in the optical axis between the image sensor 300 and the sensor-side fourteenth surface S14 of the seventh lens 107. L6_CT is the center thickness or a thickness on the optical axis of the sixth lens 106, and L6_ET is the end or edge thickness of the effective region of the sixth lens 106. L7_CT is the center thickness or a thickness in the optical axis of the seventh lens 107. D67_CT is a distance in the optical axis from the center of the sensor-side surface of the sixth lens 106 to the center of the object-side surface of the seventh lens 107 (i.e., center distance). That is, the optical axis distance D67_CT from the center of the sensor-side surface of the sixth lens 106 to the center of the object-side surface of the seventh lens 107 is a distance between the twelfth surface S12 and the thirteenth surface S13 in the optical axis OA. The D67_CT may be larger than the optical axis distance between the third and fourth lenses 103 and 104. The D67_CT may be greater than the sum of center thicknesses of the sixth and seventh lenses 106 and 107. The D67_CT may be 1.8 times or more, for example, 1.8 times to 2.5 times the center thickness of a lens having the maximum thickness in the optical system 1000, that is, the second lens 102.

The second lens group G2 may include the fourth to seventh lenses 104, 105, 106, and 107. Among the fourth to seventh lenses 104, 105, 106, and 107, a lens having a maximum center thickness may be smaller than a center distance between the third and fourth lenses 103 and 104. In the second lens group G2, the lens having the maximum center thickness may be the sixth lens 106, and the lens having the minimum center thickness may be the fifth lens 105. Accordingly, the optical system 1000 may control incident light and may have improved aberration characteristics and resolution.

An average size of the effective diameter (CA: clear aperture) of the lens among the fourth to seventh lenses 104, 105, 106, and 107 may be the smallest in the fourth lens 104, and the seventh lens 107 may be the largest. In detail, in the second lens group G2, the size of the effective diameter of the seventh surface S7 of the fourth lens 104 may be the smallest, and the size of the effective diameter of the fourteenth surface S14 may be the largest. The size of the effective diameter of the fourteenth surface S14 may be the maximum effective diameter in the optical system and may be 2.2 times greater than the size of the effective diameter of the seventh surface S7. The effective diameter of the seventh lens 107 is provided to be the largest, so that incident light may be effectively refracted toward the image sensor 300. Accordingly, the optical system 1000 may have improved chromatic aberration control characteristics, and may improve vignetting characteristics of the optical system 1000 by controlling incident light.

In the second lens group G2, the number of lenses having a refractive index exceeding 1.6 may be smaller than the number of lenses having a refractive index of less than 1.6. In the second lens group G2, the number of lenses having an Abbe number greater than 50 may be smaller than the number of lenses having an Abbe number less than 50.

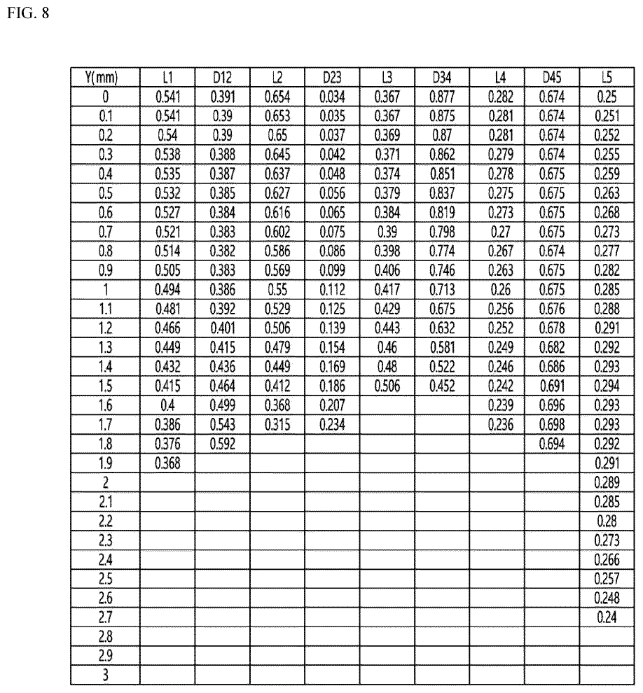

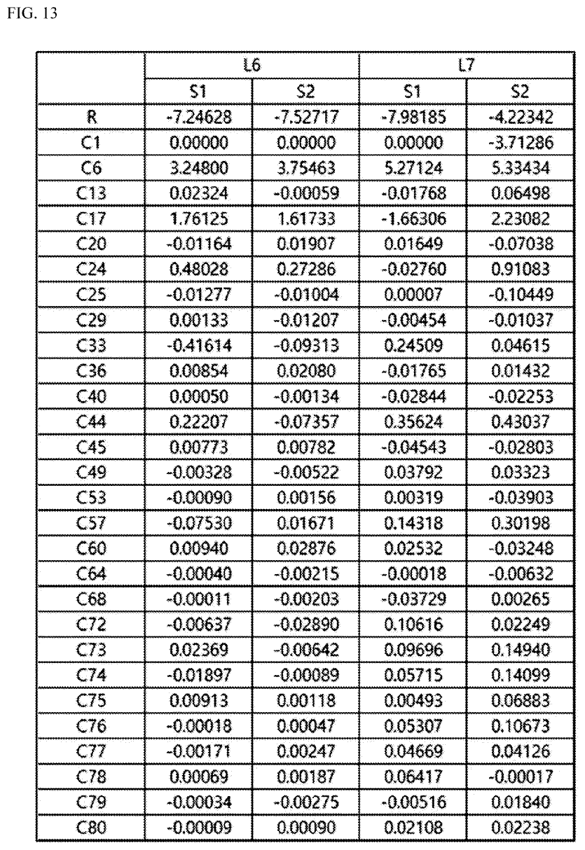

In the thickness and distance of each lens according to the first and second embodiments, as shown in FIGS. 8 and 14, the thicknesses of the first to fifth lenses 101, 102, 103, 104, and 105 are represented by L1 to L5, and the distance between two adjacent lenses is expressed as D12 (between the first and second lenses), D23 (between the second and third lenses), D34 (between the third and fourth lenses), and D45 (between the fourth and fifth lenses), and are values measured in the second direction Y orthogonal to the optical axis at intervals of 0.1 mm to 0.2 mm. The thickness L1 of the first lens 101 may gradually decrease from the optical axis toward the edge, and the center thickness of the first lens 101 may be 1.2 times or more, for example, 1.2 to 1.6 times the edge thickness.

The thickness L2 of the second lens 102 may gradually decrease from the optical axis toward the edge, and the center thickness of the second lens 102 may be 1.7 times or more, for example, 1.7 times to 2.3 times the edge thickness. The maximum thickness of the second lens 102 may be greater than the maximum thickness of the first lens 101, and the minimum thickness may be less than the minimum thickness of the first lens 101.

The distance D12 between the first lens 101 and the second lens 102 may be maximum at the center and minimum at the edge, and the maximum distance of the distance D12 may be 1.3 times or more than the minimum distance, for example, in the range of 1.3 to 1.7 times. The maximum distance may be larger than the maximum thickness of the first lens 101 and may be smaller than the maximum thickness of the second lens 102.

The thickness L3 of the third lens 103 may gradually increase from the optical axis toward the edge, and the edge thickness of the third lens 103 may be 1.1 times or more, for example, in the range of 1.1 times to 1.5 times the center thickness. The minimum thickness of the third lens 103 may be smaller than the maximum thickness of the second lens 102 and may be greater than the minimum thickness, and the maximum thickness of the second lens 102 may be smaller than the maximum thickness of the first lens 101.

The distance D23 between the second lens 102 and the third lens 103 may be minimum at the center and maximum at the edge, and the maximum distance of the distance D23 may be 4 times or more than the minimum distance, for example, in the range of 4 to 9 times. A maximum of the distance D23 may be smaller than a minimum thickness of the first and second lenses 101 and 102.

The thickness L4 of the fourth lens 104 may gradually decrease from the optical axis toward the edge, and the center thickness the fourth lens 104 may be 3 times or less than the edge thickness, for example, in a range of 1.1 times to 3 times. The maximum thickness of the fourth lens 104 may be smaller than the minimum thickness of the first, second, and third lenses 101, 102, and 103.

The distance D34 between the third lens 103 and the fourth lens 104 may be maximum at the center and minimum at the edge, and the maximum distance of the distance D34 may be 1.1 times or more than the minimum distance, for example, in the range of 1.1 times to 3 times. The maximum of the distance D34 may be greater than the maximum thickness of the second lens 102, and the maximum thickness of the second lens 102 may be greater than the minimum thickness and less than the maximum thickness of the third lens 103.

The thickness L5 of the fifth lens 105 is maximum in a region of 85%+3% from the optical axis, and may gradually decrease toward the optical axis and the edge at the maximum thickness. The maximum thickness of the fifth lens 105 may be 1.1 times or more, for example, in the range of 1.1 times to 2 times the minimum thickness. A difference between the minimum thickness and the maximum thickness of the fifth lens 105 may be 0.1 mm or less, and the maximum thickness of the fifth lens 105 may be smaller than the minimum thickness of the second lens 102.

The distance D45 between the fourth lens 104 and the fifth lens 105 may be minimum at the center and maximum at the edge, and the maximum distance of the distance D45 may be 1.01 times or more than the minimum distance, for example, in the range of 1.01 to 1.5 times. The maximum of the distance D45 may be greater than the maximum thickness of the second lens 102.

The center thickness of the second lens 102 is the largest among the center thicknesses of the lenses, and the center distance D78_CT between the seventh lens 107 and the eighth lens 108 is the largest among the center distances between the lenses. The center thickness of the third lens 103 is the minimum among the center thicknesses of the lenses, and the center distance between the second and third lenses 102 and 103 is the minimum among the center distances between the lenses.

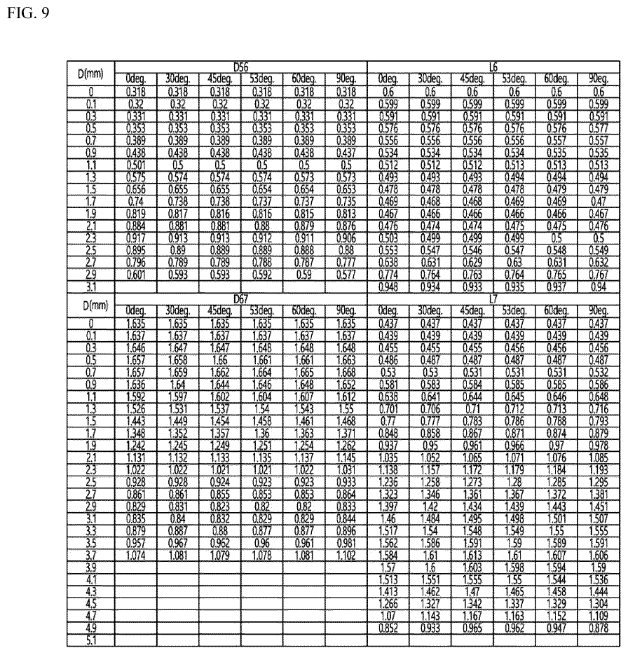

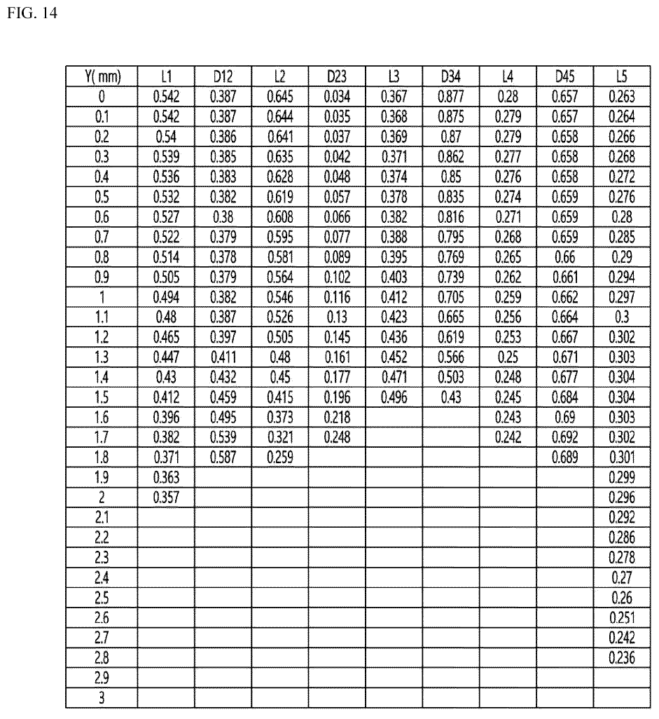

As shown in FIGS. 9 and 15, the thicknesses of the sixth and seventh lenses 106 and 107 represent L6 and L7, and the distances between two adjacent lenses represent D56 (between the fifth and sixth lenses) and D67 (between the sixth and seventh lenses), and are values measured in the second direction Y orthogonal to the optical axis at intervals of 0.1 mm to 0.2 mm. Here, the thicknesses L6 and L7 and the distances D56 and D67 were divide into 0 degrees in the first direction X orthogonal to the optical axis OA, 90 degrees in the second direction Y, and 30 degrees, 45 degrees, 53 degrees, and 60 degrees between the first and second directions X and Y.

It may be seen that the distance D56 has the same distance from the optical axis OA to a radius of less than 0.9 mm when calculating up to the third digit after the decimal point, and has a different distance in at least one direction from a radius of 0.9 mm or more. The maximum of the distance D56 may be twice or more, for example, in the range of 2 to 4 times the minimum. When the distance D56 is calculated up to the fourth digit after the decimal point, points having different distances may be located closer to the optical axis, for example, 0.3 mm+0.2 mm from the optical axis.

The thickness L6 of the sixth lens 106 has the same thickness from the optical axis OA to a radius of less than 0.7 mm when calculated to the third digit after the decimal point, and may have a different thickness in at least one direction from a radius of 0.7 mm or more. The maximum of the thickness L6 is located at the edge, the minimum is located at the center, and the maximum thickness of the thickness L6 may be 1.1 times or more, for example, 1.1 times to 3 times the minimum thickness. The maximum thickness L6 may be greater than the maximum thickness of the second lens 102, and the minimum thickness L6 may be less than the maximum thickness of the second lens 102. When the thickness L6 is calculated up to the fourth digit after the decimal point, points having different thicknesses may be located closer to the optical axis, for example, 0.4 mm+0.2 mm from the optical axis.

The distance D67 between the sixth and seventh lenses 106 and 107 has the same distance from the optical axis OA to a radius of less than 0.1 mm when calculating up to the third digit after the decimal point, and may have different distances from a radius of 0.1 mm or more in at least one direction. The maximum of the distance D67 may be located in the region of 0.7 mm+0.2 mm, and the minimum of the distance D67 may be located in the region of 2.9 mm+0.2 mm. The maximum may be at least 1.5 times the minimum, for example in the range of 1.5 to 3 times. The minimum distance D67 may be 0.6 mm or more, for example, the maximum distance D67 may be 1.2 mm or more.

The thickness L7 of the seventh lens 107 has the same thickness from the optical axis OA to a radius of less than 0.7 mm when calculated to the third digit after the decimal point, and may have a different thickness in at least one direction from a radius of 0.7 mm or more. The maximum thickness L7 is located at the edge of 3.7 mm+0.2 mm, the minimum thickness is located at the center, and the maximum thickness may be 2.6 times or more, for example, in the range of 2.6 times to 4 times the minimum thickness. The maximum thickness L7 may be the largest in the optical system 1000, and the minimum thickness L7 may be smaller than the maximum thickness of the first lens 101 and larger than the minimum thickness. When the thickness L6 is calculated up to the fourth digit after the decimal point, points having different thicknesses may be located closer to the optical axis.

FIG. 17 is a view comparing the thickness L7_T of the seventh lens in each direction (0 degree to 90 degrees) from the optical axis to the end of the effective region in the first and second embodiments. As shown in FIG. 7, from the optical axis (O) toward the end direction (horizontal axis) of the effective region, it may be seen that different thicknesses (vertical axis) at positions are shown at position in each axis direction (0 degree, 30 degree, 45 degree, 53 degree, 60 degree, 90 degree). FIG. 18 is a diagram comparing Sag heights in each direction from the optical axis to the end of the effective region for the sensor-side surface (L7S2) of the seventh lens in the first and second embodiments. As shown in FIG. 8, from the optical axis (O) toward the end (horizontal axis) of the effective region, it may be seen that different heights (Vertical axis) are shown at positions in each axis direction (0 degree, 30 degree, 45 degree, 53 degree, 60 degree, 90 degree).

Since the object-side eleventh surface S11 of the sixth lens 106 has a freeform surface, it may be seen that the distance D56 between the fifth and sixth lenses 105 and 106 may have a different distance from each other as it approaches the end height (e.g., 2.9 mm) of the effective region in directions of 30 degrees, 45 degrees, 53 degrees, and 60 degrees toward the second direction Y (90 degrees) based on the first direction X (0 degrees). Accordingly, the distance D56 between the fifth and sixth lenses 105 and 106 may have different intervals at the same point (e.g., 0.9 mm to 2.9 mm) in different directions with respect to the optical axis OA.

Since the sensor-side twelfth surface S12 of the sixth lens 106 and the object-side thirteenth surface S13 of the seventh lens 107 have freeform surfaces, it may be seen that the distance D67 between the sixth and seventh lenses 106 and 107 may have a different distance from each other as it approaches the end height (e.g., 3.7 mm) of the effective region in directions of 30 degrees, 45 degrees, 53 degrees, and 60 degrees toward the second direction Y (90 degrees) based on the first direction X (0 degrees). Accordingly, the distance D56 between the fifth and sixth lenses 105 and 106 may have different intervals at the same point (e.g., 0.3 mm to 3.7 mm) in different directions with respect to the optical axis OA.

The thickness of the sixth lens 106 may have different thicknesses at the same distances of the different directions (0 degree, 30 degree, 45 degree, 53 degree, 60 degree, 90 degree) from a distance of 0.9 mm or more with respect to the optical axis OA to the end of the effective region. The thickness of the seventh lens 107 may have different thicknesses at the same distances of the different directions (0 degree, 30 degree, 45 degree, 53 degree, 60 degree, 90 degree) from a distance of 0.7 mm or more with respect to the optical axis OA to the end of the effective region.

The refractive index of the fifth lens 105 may be greater than that of the sixth and seventh lenses 106 and 107 and may be greater than 1.6. The fifth lens 105 may have an Abbe number smaller than that of the sixth and seventh lenses 106 and 107. For example, the Abbe number of the fifth lens 105 may be smaller by a difference of 20 or more from the Abbe number of the seventh lens 107. In detail, the Abbe number of the seventh lens 107 may be 30 or more greater than the Abbe number of the fifth lens 105, for example, 50 or more. Accordingly, the optical system 1000 may have improved chromatic aberration control characteristics.

The maximum center thickness among the thicknesses of the lenses 101 to 107 may be twice or more, for example, 2 to 5 times the minimum center thickness. The second lens 102 having the maximum center thickness may be twice or more, for example, 2 times to 5 times greater than the fifth lens 105 having the minimum center thickness. Among the plurality of lenses 100, the number of lenses having a center thickness of less than 0.5 mm may be greater than the number of lenses having a center thickness of 0.5 mm or more. Accordingly, the optical system 1000 may be provided with a structure having a slim thickness. Among the plurality of lens surfaces S1 to S14, the number of surfaces having an effective radius of less than 2 mm may be greater than the number of surfaces having an effective radius of 2 mm or more. Describing the curvature radius as an absolute value, the curvature radius of the fourth surface S4 of the second lens 102 among the plurality of lenses 100 may be the largest among the lens surfaces on the optical axis OA, and the first lens, and the curvature radius of the first surface S1 of the first lens 101 may be the smallest among lens surfaces on the optical axis OA.

When the focal length is described as an absolute value, the focal length of the fourth lens 106 among the plurality of lenses 100 may be the largest among the lenses, the focal length of the seventh lens 107 may be the smallest, and the maximum focal length of the focal lengths may be more than four times the minimum focus length.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure.

$$1 < L1\_CT / L3\_CT < 5 \qquad [ Equation 1 ]$$

In Equation 1, L1_CT means the thickness (mm) of the first lens 101 in the optical axis OA, and L3_CT means the thickness (mm) of the third lens 103 in the optical axis OA. When the optical system 1000 satisfies Equation 1, the optical system 1000 may improve aberration characteristics. Preferably, Equation 1 above may satisfy: 1<L1_CT/L3_CT≤3.

$$0.5 < L3\_CT / L4\_CT < 2 \qquad [ Equation 2 ]$$

In Equation 2, L3_CT means the thickness (mm) of the third lens 103 along the optical axis OA, and L4_CT means the thickness (mm) of the fourth lens 104 along the optical axis OA. When the optical system 1000 satisfies Equation 2, the optical system 1000 may have improved chromatic aberration control characteristics. Preferably, Equation 2 above may satisfy: 1<L3_CT/L4_CT≤1.5.

$$( L1\_CT + L3\_CT ) > L2\_CT \qquad [ Equation 2 - 1 ]$$

In Equation 2-1, the thickness L2_CT of the second lens 102 in the optical axis OA may be less than the sum of the center thickness L1_CT of the first lens 101 and the center thickness L3_CT of the third lens 103. When the optical system 1000 satisfies Equation 2-1, the optical system 1000 may have improved chromatic aberration control characteristics.

$$1 < L7\_CT / L6\_CT < 2 \qquad [ Equation 3 ]$$

In Equation 3, L7_CT means the thickness (mm) of the seventh lens 107 in the optical axis OA, and L6_CT means the thickness (mm) of the sixth lens 106 in the optical axis OA. In detail, when the optical system 1000 satisfies Equation 3, the optical system 1000 may have improved chromatic aberration control characteristics.

$$0.1 < L1\_CT / L7\_CT < 3 \qquad [ Equation 4 ]$$

$$0 < L7\_CT / L2\_CT < 1 \qquad [ Equation 5 ]$$

$$1 < L2\_CT / L3\_CT < 3. \qquad [ Equation 6 ]$$

When the optical system 1000 satisfies Equations 4 to 6, the optical system 1000 may have improved chromatic aberration control characteristics. Accordingly, the thicknesses of the first, second, and seventh lenses 101, 102, and 107 may satisfy: L8_CT<L1_CT<L2_CT and L3_CT<L1_CT<L2_CT.

$$0.01 < D12\_CT / D67\_CT < 1 \qquad [ Equation 7 ]$$

In Equation 7, D12_CT means an optical axis distance (mm) between the first lens 101 and the second lens 102. In detail, D12_CT means the distance (mm) of the second surface S2 of the first lens 101 and the third surface S3 of the second lens 102 in the optical axis OA. The D67_CT means an optical axis distance (mm) between the center of the twelfth surface S12 of the sixth lens 106 and the center of the thirteenth surface S13 of the seventh lens 107. When the optical system 1000 according to the embodiment satisfies Equation 7, the optical system 1000 may improve aberration characteristics, and control the size of the optical system 1000, for example, TTL reduction. Preferably, Equation 7 may satisfy: 0.01<D12_CT/D67_CT≤0.5.

$$1 < G1\_TD / D34\_CT < 5 \qquad [ Equation 8 ]$$

In Equation 8, G1_TD means the distance (mm) in the optical axis between the first object-side surface S1 of the first lens 101 and the sensor-side sixth surface S6 of the third lens 103. D34_CT means an optical axis distance (mm) between the third lens 103 and the fourth lens 104. When the optical system 1000 satisfies Equation 8, the thickness of the first lens group G1 and the optical axis distance between the second lens group G2 may be set, and the aberration characteristics of the optical system 1000 may be improved, and may control a reduction of TTL.

$$1 < G2\_TD / D67\_CT < 5 \qquad [ Equation 9 ]$$

In Equation 8, G2_TD means the distance (mm) in the optical axis between the seventh object-side surface S7 of the fourth lens 104 and the fourteenth sensor-side surface S14 of the seventh lens 107. D67_CT means an optical axis distance (mm) between the sixth lens 106 and the seventh lens 107. Equation 9 may set the total optical axis distance of the second lens group G2 and the largest distance within the second lens group G2. When the optical system 1000 according to the embodiment satisfies Equation 9, the optical system 1000 may improve aberration characteristics, and control the size of the optical system 1000, for example, TTL reduction. Preferably, the value of Equation 8 may be 2 or more and 4 or less.

Also, Equation 8 or/and 9 may further satisfy at least one of Equations 9-1 to 9-7 below.

$$G 1 \_TD < G2\_TD \qquad [ Equation 9 - 1 ]$$

$$D34\_CT < D67\_CT \qquad [ Equation 9 - 2 ]$$

$$G1\_TD > D67\_CT \qquad [ Equation 9 - 3 ]$$

$$1 < G2\_TD / G1\_TD < 4 \qquad [ Equation 9 - 4 ]$$

$$1 < nL / D67\_CT < 3 \qquad [ Equation 9 - 5 ]$$

Here, nL is the number of lenses in the optical system 1000, and may be in the range of 6 to 8 or 7, for example.

$$2 < nL / G2\_TD < 5 \qquad [ Equation 9 - 6 ]$$

$$1 < nL / G1\_TD < 3 \qquad [ Equation 9 - 7 ]$$

$$0 < ( L6\_CT + L7\_CT ) / D67\_CT < 1 \qquad [ Equation 10 ]$$

In Equation 10, the sum of the center thickness L6_CT of the sixth lens 106 and the center thickness L7_CT of the seventh lens 107 may be smaller than the optical axis distance D67_CT between the sixth and seventh lenses 106 and 107. When the optical system 1000 satisfies Equation 10, the optical system 1000 may improve aberration characteristics and slimly control TTL.

$$0 < L 1 R 1 / L 7 R 2 < 5 \qquad [ Equation 11 ]$$

In Equation 11, LIRI means the curvature radius (mm) of the first surface S1 of the first lens 101 on the optical axis OA, and L7R2 means the curvature radius (mm) of the fourteenth surface S14 of the seventh lens 107 on the optical axis OA. When the optical system 1000 according to the embodiment satisfies Equation 11, it is possible to improve optical performance by controlling the shape and refractive power of the first and seventh lenses.

Equation 11 may further include at least one of Equations 11-1 to 11-3 for the surface shape, refractive power, and optical performance of the lens of the optical system 1000.

$$1 < \vert L 5 R 1 / L 7 R 2 \vert < 30 \qquad [ Equation 11 - 1 ]$$

In Equation 10-1, L5R1 means the curvature radius (mm) of the ninth surface S9 of the fifth lens 105 on the optical axis OA. When Equation 11-1 is satisfied, the shape and refractive power of the fifth and seventh lenses may be controlled, and the optical performance of the second lens group G2 may be improved.

$$1 < \vert L 5 R 1 / L 6 R 2 \vert < 10 \qquad [ Equation 11 - 2 ]$$

In Equation 11-2, L6R2 means the curvature radius (mm) of the twelfth surface S12 of the sixth lens 106 on the optical axis OA. When Equation 11-2 is satisfied, the shape and refractive power of the fifth and sixth lenses may be controlled.

$$0 < \vert L 5 R 1 / L 2 R 2 \vert < 1 \qquad [ Equation 11 - 3 ]$$

In Equation 11-3, L2R2 means the curvature radius (mm) of the fourth surface S4 of the second lens 102 on the optical axis OA. When Equation 11-3 is satisfied, the shape and refractive power of the second and fifth lenses may be controlled.

Here, the curvature radius of the fourth surface S4 of the second lens 102 is maximum, and its absolute value may exceed 100, and the ninth surface S9 of the fifth lens 105, an absolute value of the curvature radius of the twelfth surface S12 of the sixth lens 106 may be less than 100, and may satisfy: L2R2>L5R1>L6R2.

$$10 < ( \vert L 5 R 1 \vert / L2\_CT ) / nL < 90 \qquad [ Equation 12 ]$$

When Equation 12 is satisfied, the refractive power of the second and fifth lenses may be controlled, and optical performance of incident light may be improved.

Equation 12 may further include at least one of Equations 12-1 to 12-2 below.

$$10 < ( {L\_R}_{-} Max / {L\_CT}_{-} Max ) / nL < 90 \qquad [ Equation 12 - 1 ]$$

In Equation 12-1, L_R_Max is the maximum curvature radius on the optical axis (OA) among the first to sixteenth surfaces S1-S16, and L_CT_Max is the maximum thickness among the first to seventh lenses 101 to 107 in the optical axis.

$$10 < {L\_R2}_{-} Max / {L\_CT}_{-} Max ) / nL < 90 \qquad [ Equation 12 - 2 ]$$

In Equation 12-2, L_R2_Max is the maximum value of the curvature radius R2 of the sensor-side surfaces of the first to seventh lenses 101 to 107, and nL is the number of lenses in the optical system 1000.

$$0 < D6\_CT / D67\_CT < 1 \qquad [ Equation 13 ]$$

Equation 13 may set the thickness D6_CT of the sixth lens 106 in the optical axis and the distance D67_CT of the sixth and seventh lenses 106 and 107 in the optical axis. When the optical system satisfies Equation 13, the optical system 1000 may improve aberration characteristics and control the size of the optical system 1000, for example, TTL reduction.

$$0 < ( D67\_CT ) / InfX 72 < 1.2 \qquad [ Equation 14 ]$$

In Equation 14, D67_CT is the optical axis distance between the sixth and seventh lenses 106 and 107, and InfX72 is a straight-line distance (mm) from the optical axis OA to the critical point P8 in the X-axis direction located on the sensor-side surface S14 of the seventh lens 107. The critical point P8 may be a first critical point in the X-axis direction adjacent to the optical axis OA. When the optical system satisfies Equation 14, the optical performance of the optical system having a freeform surface lens may be improved, for example, distortion aberration characteristics at the periphery portion in the X-axis direction. Preferably, the value of Equation 14 may be 0.5 or more and 1 or less.

$$0 < ( D67\_CT ) / InfY 72 < 1.2 \qquad [ Equation 15 ]$$

In Equation 15, InfY72 is a straight-line distance (mm) from the optical axis OA to the critical point P4 in the Y-axis direction located on the sensor-side surface S14 of the seventh lens 107. The critical point P4 may be a first critical point in the Y-axis direction adjacent to the optical axis OA. When the optical system satisfies Equation 15, optical performance, for example, distortion aberration characteristics at the periphery portion in the Y-axis direction may be improved. Preferably, the value of Equation 15 may be 0.5 or more and 1 or less, and may have a difference of 0.2 or less from the value of Equation 14. Also, InfX72 and InfY72 may differ from each other, and the difference may be less than 0.5 mm.

$$0 < ( D 67 \_CT ) / Inf 72 < 1.2 \qquad [ Equation 16 ]$$

In Equation 16, Inf72 is the average value of the straight-line distance (mm) from the optical axis OA to the critical point P4 in the Y-axis direction located on the sensor-side surface S14 of the seventh lens 107 and a distance from the optical axis to the critical point P8 in the X-axis direction. When the optical system satisfies Equation 16, optical performance, for example, distortion aberration characteristics at the periphery portion in the X and Y axis directions may be improved.

$$1.6 < n 3 \qquad [ Equation 17 ]$$

In Equation 17, n3 means the refractive index of the third lens 103 at the d-line. When the optical system 1000 according to the embodiment satisfies Equation 17, the optical system 1000 may improve chromatic aberration characteristics.

Equation 17 may include at least one of Equations 17-1 to 17-5 below.

$$1.50 < n 1 < 1.6 \qquad [ Equation 17 - 1 ]$$

$$1.5 < n 7 < 1.6 \qquad [ Equation 17 - 2 ]$$

$$1.52 < \sum Index / nL < 1.62 \qquad [ Equation 17 - 3 ]$$

$$1.52 < \sum Index / TTL < 1.62 \qquad [ Equation 17 - 4 ]$$

$$1.52 < \sum Index / Imgh < 1. 62 \qquad [ Equation 17 - 5 ]$$

In Equations 17-1 to 17-5, n1 is the refractive index of the first lens 101 at the d-line, n7 is the refractive index of the seventh lens 107 at the d-line, and ΣIndex is a sum of the refractive indices of the first to seventh lenses, the TTL is the optical axis distance from the object-side surface of the first lens to the image sensor, and the Imgh means ½ of the diagonal length of the image sensor. When the optical system 1000 according to the embodiment satisfies at least one of Equations 17-1 to 17-5, chromatic aberration characteristics may be improved.

$$0.5 < n 2 / n 3 < 1.2 \qquad [ Equation 18 ]$$

n2 is the refractive index at the d-line of the second lens 102, n3 is the refractive index at the d-line of the third lens 103, and when Equation 18 is satisfied, the lens resolution may be adjusted.

$$1.65 < AVR ( n 3 , n 5 ) < 1.75 \qquad [ Equation 19 ]$$

In Equation 19, n5 means the refractive index at the d-line of the fifth lens 105, and AVR (n3, n5) means the average refractive index of the third and fifth lenses 103 and 105. When the optical system 1000 according to the embodiment satisfies Equation 19, the optical system 1000 may improve chromatic aberration characteristics.

$$1 < CA\_L1S1 / CA\_L3S1 < 2 \qquad [ Equation 20 ]$$

In Equation 20, CA_L1S1 means a size (mm) of the effective diameter CA (clear aperture) of the first surface S1 of the first lens 101, CA_L3S1 means a size (mm) of the effective diameter CA of the fifth surface S5 of the third lens 103. When the optical system 1000 according to the embodiment satisfies Equation 20, the optical system 1000 may control light incident to the first lens group G1 and may have improved aberration control characteristics. The value of Equation 20 may be 1.5 or less.

$$1 < CA\_L7S2 / CA\_L4S2 < 5 \qquad [ Equation 21 ]$$

In Equation 21, CA_L4S2 means the effective diameter CA (mm) of the eighth surface S8 of the fourth lens 104, and CA_L7S2 means the effective diameter CA (mm) of is the effective diameter of the fourteenth surface S14 of the seventh lens 107. When the optical system 1000 according to the embodiment satisfies Equation 19, the optical system 1000 may control the path of light traveling through the second lens group G2 and may have improved aberration control characteristics. The value of Equation 21 may be 4 or less.

$$0.2 < CA\_L3S2 / CA\_L4S1 < 2 \qquad [ Equation 22 ]$$

In Equation 20, CA_L3S2 means the size (mm) of the effective diameter CA of the sixth surface S6 of the third lens 103, and CA_L4S1 means the size (mm) of the effective diameter CA of the seventh surface S7 of the fourth lens 104. When the optical system 1000 according to the embodiment satisfies Equation 22, the optical system 1000 may improve chromatic aberration, and the lens surfaces of the first lens group G1 and the second lens group G2 face each other. s length may be set, and vignetting may be controlled for optical performance.

$$1 < CA\_L5S2 / CA\_L7S2 < 2 \qquad [ Equation 23 ]$$

In Equation 23, CA_L5S2 means the size (mm) of the effective diameter CA of the tenth surface S10 of the fifth lens 105. When the optical system 1000 according to the embodiment satisfies Equation 23, the optical system 1000 may control light traveling to the fifth to seventh lenses 105, 106, and 107, and may improve aberration characteristics.

$$1 < \vert L 6 R 1 / L6\_CT \vert < 30 \qquad [ Equation 24 ]$$

In Equation 24, L6R1 means the curvature radius (mm) of the eleventh surface S11 of the sixth lens 106, and L6_CT means the thickness of the sixth lens 106 in the optical axis. That is, Equation 22 may satisfy: L6R1>L6_CT, and the value of Equation 24 may be 5 or more and 20 or less. When the optical system 1000 according to the embodiment satisfies Equation 24, the aberration characteristics of the optical system 1000 may be improved.

$$1 < \vert L 5 R 1 / L 7 R 1 \vert < 5 \qquad [ Equation 25 ]$$

In Equation 25, L5R1 means the curvature radius (mm) of the ninth surface S9 of the fifth lens 105, and L7R1 means the curvature radius (mm) of the thirteenth surface S13 of the seventh lens 107. When the optical system 1000 according to the embodiment satisfies Equation 25, the aberration characteristics of the optical system 1000 may be improved. The value of Equation 25 may be 10 or less.

$$0 < L 2 R 1 / \vert L 2 R 2 \vert < 0.5 \qquad [ Equation 26 ]$$

$$0 < \vert L 3 R 2 / L 3 R 1 \vert < 1 \qquad [ Equation 27 ]$$

In Equations 26 and 27, L2R1 and L2R2 mean the curvature radii (mm) of the third and fourth surfaces S3 and S4 of the second lens 102, and L3R1 and L3R2 the curvature radii (mm) of the curvature radius (mm) of the fifth and sixth surfaces S5 and S6. When the optical system 1000 satisfies Equations 26 and 27, the aberration characteristics of the optical system 1000 may be improved. The values of Equations 16 and 27 may be 1 or less.

$$0 \leq \vert EFLX - EFLY \vert \leq 0.1 \qquad [ Equation 28 ]$$

In Equation 28, EFLX is the effective focal length of the optical system in the first direction X, and EFLY is the effective focal length of the optical system in the second direction Y. EFLX and EFLY may be different from each other. In an optical system having a free curved lens, focal lengths in two directions orthogonal to the optical axis OA may be equal to or different from each other. For example, the value of Equation 28 may be greater than zero.

$$0 \leq F27\_X / F27\_Y \leq 0.1 or 0 < F27\_X / F27\_Y \leq 0.1 \qquad [ Equation 28 - 1 ]$$

$$F 12 < F27\_X \qquad [ Equation 28 - 2 ]$$

$$F 12 < F27\_Y$$

$$F47\_X \neq F47\_Y \qquad [ Equation 28 - 3 ]$$

$$F47\_X < F47\_Y$$

In Equation 28-1, F27_X and F27_Y are composite focal lengths of the second to seventh lenses in the first direction X and the second direction Y, and may be the same or different. In Equation 28-2, F12 is the composite focal length of the first and second lenses. In Equation 28-3, F47_X and F47_Y are composite focal lengths of the fourth to seventh lenses along the first and second directions X and Y.

$$0 < L\_CT \_Max / Air\_CT \_Max < 5 \qquad [ Equation 29 ]$$

In Equation 29, L_CT_Max means the thickest thickness (mm) in the optical axis OA of each of the plurality of lenses, and Air_CT_Max means the maximum value of the optical axis interval between the plurality of lenses. When the optical system 1000 according to the embodiment satisfies Equation 29, the optical system 1000 has good optical performance at the set FOV and focal length, and may reduce the size of the optical system 1000, for example, TTL. The value of Equation 29 may be 3 or less or 1 or less.

$$0 < L\_CT \_Max / nL < 0.5 \qquad [ Equation 29 - 1 ]$$

$$0.2 < Air\_CT \_Max / nL < 0.5 \qquad [ Equation 29 - 2 ]$$

$$0 < L\_CT \_Max / TTL < 0.5 \qquad [ Equation 29 - 3 ]$$

$$0.2 < Air\_CT \_Max / Imgh < 0.5 \qquad [ Equation 29 - 4 ]$$

Equation 29 may include at least one of Equations 29-1 to 29-4.

$$0.5 < \sum L\_CT / \sum Air\_CT < 2 \qquad [ Equation 30 ]$$

In Equation 30, ΣL_CT means the sum of the thicknesses (mm) in the optical axis OA of each of the plurality of lenses, and ΣAir_CT means the sum of the distances (mm) in the optical axis OA between two adjacent lenses in the plurality of lenses. When the optical system 1000 according to the embodiment satisfies Equation 30, the optical system: 1000 has good optical performance at the set POV and focal length, and may reduce the size of the optical system 1000, for example; TTL.

$$0 < \sum L\_CT / nL < 0.7 \qquad [ Equation 30 - 1 ]$$

$$0.2 < \sum Air\_CT / nL < 0.8 \qquad [ Equation 30 - 2 ]$$

$$0 < \sum L\_CT / TTL < 0.7 \qquad [ Equation 30 - 3 ]$$

$$0 < \sum Air\_CT / TTL < 0.9 \qquad [ Equation 30 - 4 ]$$

$$0.2 < \sum L\_CT / Imgh < 0.7 \qquad [ Equation 30 - 5 ]$$

$$0.2 < \sum Air\_CT / Imgh < 0.9 \qquad [ Equation 30 - 6 ]$$

Equation 30 may include at least one or two or more of Equations 30-1 to 30-6.

$$9 < \sum Index < 20 \qquad [ Equation 31 ]$$

In Equation 31, ΣIndex means the sum of the refractive indices of each d-line of the plurality of lenses 100. When the optical system 1000 according to the embodiment satisfies Equation 31, TTL of the optical system 1000 may be controlled and resolution may be improved.

$$10 < \sum Abb / \sum Index < 50 \qquad [ Equation 32 ]$$

In Equation 32, ΣAbbe means the sum of Abbe numbers of each of the plurality of lenses 100. When the optical system 1000 according to the embodiment satisfies Equation 32, the optical system 1000 may have improved aberration characteristics and resolution.

Equation 32 may further satisfy at least one of Equations 32-1 to 32-3.

$$20 < ( \sum Abb + \sum Index ) / nL < 50 \qquad [ Equation 32 - 1 ]$$

$$30 < \sum Abb / nL < 50 \qquad [ Equation 32 - 2 ]$$

$$30 < \sum Abb / TTL < 50 \qquad [ Equation 32 - 3 ]$$

$$30 < \sum Abb / Imgh < 50 \qquad [ Equation 32 - 4 ]$$

The ΣAbbe means the sum of Abbe numbers of each of the plurality of lenses 100, and nL is the number of lenses in the optical system, and may be in the range of 6 to 8 or 8, for example.

$$0.5 < CA\_L1S1 / CA\_min < 2 \qquad [ Equation 33 ]$$

In Equation 33, CA_L1S1 means the effective diameter (mm) of the first surface S1 of the first lens 101, and CA_Min means the smallest effective diameter (mm) of the first to fourteenth surfaces S1-S14. When the optical system 1000 according to the embodiment satisfies Equation 33, it is possible to control light incident through the first lens 101 and provide a slim optical system while maintaining optical performance.

$$1 < CA\_max / CA\_min < 5 \qquad [ Equation 34 ]$$

In Equation 34, CA_max means the largest effective diameter (mm) among the object-side and sensor-side surfaces of the plurality of lenses, and means the largest effective diameter (mm) among the first to fourteenth surfaces S1-S14. When the optical system 1000 according to the embodiment satisfies Equation 34, the optical system 1000 may provide a slim and compact optical system while maintaining optical performance. The effective diameter of the fourteenth surface S14 may have a maximum effective diameter, and the effective diameter of the sixth surface S6 may have a minimum effective diameter.

Equation 34 may include at least one of Equations 34-1 to 34-4.

$$1 < CA\_L8 / CA\_L3 < 5 \qquad [ Equation 34 - 1 ]$$

$$1 < CA\_L8 / CA\_L4 < 5 \qquad [ Equation 34 - 2 ]$$

$$1 < CA\_L8 / CA\_L2 < 5 \qquad [ Equation 34 - 3 ]$$

$$CA\_L3 < CA\_L4 < CA\_L2 < CA\_L5 \qquad [ Equation 34 - 4 ]$$

Here, CA_L2, CA_L3, CA_L4, CA_L5, and CA_L8 are average values of the effective diameters of the object-side surface and the sensor-side surface of each lens. When the optical system satisfies Equations 34-1 to 34-4, the optical system 1000 may provide a slim and compact optical system while maintaining optical performance.

$$1 < CA\_max / CA\_AVR < 3 \qquad [ Equation 35 ]$$

In Equation 35, CA_max means the largest effective diameter (mm) among the object-side and sensor-side surfaces of the plurality of lenses, and CA_AVR means the average of the effective diameters of the object-side and sensor-side surfaces of the plurality of lenses. When the optical system 1000 according to the embodiment satisfies Equation 35, a slim and compact optical system may be provided.

$$0.1 < CA\_min / CA\_AVR < 1 \qquad [ Equation 36 ]$$

In Equation 36, CA_min means the smallest effective diameter (mm) among the object-side and sensor-side surfaces of the plurality of lenses. When the optical system 1000 according to the embodiment satisfies Equation 36, a slim and compact optical system may be provided.

$$0.1 < CA\_max / ( 2 * ImgH ) < 1 \qquad [ Equation 37 ]$$

In Equation 37, CA_max means the largest effective diameter among the object side and sensor side of the plurality of lenses, and ImgH means a distance (mm) from the center (0.0F) of the image sensor 300 overlapping the optical axis OA to the diagonal end (1.0F). That is, the ImgH means ½ of the maximum diagonal length (mm) of the effective region of the image sensor 300. When the optical system 1000 according to the embodiment satisfies Equation 37, the optical system 1000 has good optical performance in the center and periphery portion of the FOV, and may provide a slim and compact optical system. Here, * represents multiplication.

Equation 37 may include the following Equations 37-1 and 37-2.

$$0.5 < ImgH / nL < 2 \qquad [ Equation 37 - 1 ]$$

$$0.5 < TTL / nL < 2 \qquad [ Equation 37 - 2 ]$$

nL is the number of lenses of the optical system, for example, 6 to 8, preferably 7, and TTL means the distance (mm) in the optical axis OA from the apex of the first surface S1 of the first lens 101 to the image surface of the image sensor 300.

$$0.5 < TD / CA\_max < 1.5 \qquad [ Equation 38 ]$$

In Equation 38, TD is the optical axis distance (mm) from the object-side surface of the first lens 101 to the n-th lens, that is, the sensor-side surface of the eighth lens 108. For example, it is the distance from the first surface S1 to the sixteenth surface S16 on the optical axis OA. When the optical system 1000 according to the embodiment satisfies Equation 38, a slim and compact optical system may be provided.

$$0 < F / L 7 R 2 < 10 \qquad [ Equation 39 ]$$

In Equation 39, F means the total focal length (mm) of the optical system 1000, and L7R2 means the curvature radius (mm) of the fourteenth surface S14 of the seventh lens 107 having a freeform surface. When the optical system 1000 according to the embodiment satisfies Equation 39, the optical system 1000 may reduce the size of the optical system 1000, for example, reduce the TTL.

$$1 < F / L 1 R 1 < 10 \qquad [ Equation 40 ]$$

In Equation 40, LIRI means the curvature radius (mm) of the first surface S1 of the first lens 101. When the optical system 1000 according to the embodiment satisfies Equation 40, the size of the optical system 1000 may be reduced, for example, a TTL may be reduced. The value of Equation 40 may be 5 or less. for example, 3 or less.

$$0 < EPD / L 7 R 2 < 10 \qquad [ Equation 41 ]$$

In Equation 41, EPD means the size (mm) of the entrance pupil of the optical system 1000, and L7R2 means the curvature radius (mm) of the fourteenth surface S14 of the seventh lens 107 having a freeform surface. When the optical system 1000 according to the embodiment satisfies Equation 41, the optical system 1000 may control overall brightness and may have good optical performance in the center and periphery portions of the FOV. The value of Equation 41 may be 5 or less, for example, 3 or less.

$$0.5 < EPD / L 1 R 1 < 8 \qquad [ Equation 42 ]$$

Equation 42 represents the relationship between the size of the entrance pupil (EPD) of the optical system and the curvature radius of the first surface S1 of the first lens 101, and may control incident light. The value of Equation 42 may be 5 or less, for example, 3 or less.

$$- 3 < F 1 / F 3 < 0 \qquad [ Equation 43 ]$$

In Equation 43, F1 means the focal length (mm) of the first lens 101, and F3 means the focal length (mm) of the third lens 103. When the optical system 1000 according to the embodiment satisfies Equation 43, it may have appropriate refractive power for controlling light paths traveling through the first lens 101 and the third lens 103, and improve resolving power.

$$0 < F 13 / F < 5 \qquad [ Equation 44 ]$$

In Equation 44, F13 means the composite focal length (mm) of the first to third lenses, and F means the effective focal length (mm) in two directions X and Y orthogonal to the optical axis OA in the optical system 1000. That is, the effective focal length Fx in the X direction and the effective focal length Fy in the Y direction are different from each other, and their average may be defined as F. Equation 44 establishes a relationship between the focal length of the first lens group G1 and the total effective focal length. When the optical system 1000 according to the embodiment satisfies Equation 44, the optical system 1000 may control a TTL of the optical system 1000.

$$0 < \vert F 47 / F 13 \vert < 10 \qquad [ Equation 45 ]$$

In Equation 45, F13 means the composite focal length (mm) of the first to third lenses, and F47 means the composite focal length (mm) of the fourth to seventh lenses. Equation 45 establishes a relationship between the focal length of the first lens group G1 and the focal length of the second lens group G2. In an embodiment, the composite focal length of the first to third lenses may have a positive (+) value, and the composite focal length of the fourth to seventh lenses may have a negative (−) value. When the optical system 1000 according to the embodiment satisfies Equation 45, the optical system 1000 may improve aberration characteristics such as chromatic aberration and distortion aberration. The value of Equation 45 may be 8 or less, for example, 5 or less.

At least one of Equations 44 and 45 may include Equations 45-1 to 45-4.

$$- 10 < F 47 / F < 0 \qquad [ Equation 45 - 1 ]$$

$$0 < F / nL < 2 \qquad [ Equation 45 - 2 ]$$

$$1 < ( F 13 + \vert F 47 \vert + F ) / nL < 5 \qquad [ Equation 45 - 3 ]$$

$$0.5 < ( F 13 + \vert F 47 \vert ) / nL < 4 \qquad [ Equation 45 - 4 ]$$

Here, nL is the number of lenses in the optical system, and may be in the range of 6 to 8 or 8.

$$0.5 < F 2 / F < 1.5 \qquad [ Equation 46 ]$$

In Equation 46, F2 is the focal length of the second lens 102, and F is the average value of effective focal lengths in the X and Y directions of the optical system. As Equation 46 is satisfied, the optical system and the camera module may improve chromatic aberration characteristics by setting the ratio of average effective focal lengths in two directions X and Y orthogonal to the second lens and the optical axis to a set range.

Equation 46 may include at least one of Equations 46-1 to 46-6 below.

$$1.5 < F 1 / F < 3.2 \qquad [ Equation 46 - 1 ]$$

$$0.5 < F 3 / F < 2 \qquad [ Equation 46 - 2 ]$$

$$- 5 < F 4 / F < 0 \qquad [ Equation 46 - 3 ]$$

$$1 < F 5 / F < 10 \qquad [ Equation 46 - 4 ]$$

$$- 2.5 < F 6 / F < 0 \qquad [ Equation 46 - 5 ]$$

$$0.5 < F 7 / F < 3 \qquad [ Equation 46 - 6 ]$$

$$- 1.5 < F 8 / F < 0 \qquad [ Equation 46 - 7 ]$$

In Equations 46-1 to 46-7, F1, F3, F4, and F5 are the focal lengths of the first and second lenses, and F6 and F7 are the average effective focal lengths of the sixth and seventh lenses in the X and Y directions, and F is the average value of the effective focal lengths in the X and Y directions of the optical system. As the optical system satisfies Equations 36, 46-1 to 46-6, the ratio of the average effective focal length of each lens and the two directions X and Y orthogonal to the optical axis is set to a set range, and the distortion and chromatic aberration characteristics may improve

$$- 5 < F 2 / F 3 < 0 \qquad [ Equation 47 ]$$

The optical system may improve distortion and chromatic aberration characteristics by setting the ratio of the focal lengths of the second and third lenses to a set range according to Equation 47.

$$0.8 < F 2 / F 12 < 1.8 \qquad [ Equation 48 ]$$

In Equation 48, F12 is the composite focal length of the first and second lenses. The optical system may improve the distortion and chromatic aberration characteristics of the first lens group G1 by setting the ratio of the focal lengths of the first and second lenses to a set range according to Equation 48.

$$0.5 < F 12 / F < 1.5 \qquad [ Equation 49 ]$$

As Equation 49 is satisfied, the optical system sets the ratio of the composite focal length of the first and second lenses to the average effective focal length in two directions X and Y orthogonal to the optical axis to a set range, thereby calculating distortion and chromatic aberration characteristics. may be improved

$$1 < F 27 / F < 4 \qquad [ Equation 50 ]$$

As the optical system satisfies Equation 50, the ratio of the average value of the average effective focal length F in the two directions X and Y orthogonal to the optical axis and the composite focal length of the lenses 2-7 is set to a set range, and distortion aberration and chromatic aberration characteristics may be improved.

$$2 < TTL < 20 \qquad [ Equation 51 ]$$

In Equation 51, TTL means the distance (mm) on the optical axis OA from the center of the first surface S1 of the first lens 101 to the image surface of the image sensor 300. By setting TTL to less than 20 in Equation 51, a slim and compact optical system may be provided.

Equation 51 may further include Equation 51-1.

$$1 < ( TTL + Imgh ) / nL < 5 \qquad [ Equation 51 - 1 ]$$

Here, nL is the number of lenses in the optical system, and may be 6 to 8, preferably 7.

$$2 < ImgH \qquad [ Equation 52 ]$$

Equation 52 may provide an optical system having high resolution by exceeding the diagonal size of the image sensor 300 exceed 4 mm. ImgH may be greater than 4 mm.

$$BFL < 2.5 \qquad [ Equation 53 ]$$

Equation 53 may secure an installation space of the filter 50 by making the BFL (Back focal length) less than 2.5 mm, improve assembly of the components through the distance (mm) between the image sensor 300 and the last lens and improve coupling reliability. That is, when the sensor-side surface of the last lens does not have a critical point, the BFL value may be set to less than 2.5 mm, i.e., 2 mm or less.

$$2 < F < 20 \qquad [ Equation 54 ]$$

In Equation 54, the average value of the first and second directions of the total focal length F may be set according to the optical system.

$$FOV < 120 \qquad [ Equation 55 ]$$

In Equation 55, FOV means a degree of view of the optical system 1000, and an optical system of less than 120 degrees may be provided. FOV may be 100 degrees or less.

$$0.5 < TTL / CA\_max < 2 \qquad [ Equation 56 ]$$

In Equation 56, CA_max means the largest effective diameter (mm) among the object-side and sensor-side surfaces of the plurality of lenses, and TTL (Total track length) means the distance from an apex of the first surface S1 of the first lens 101 to the image surface of the image sensor 300 in the optical axis OA. Equation 56 establishes a relationship between the total length in the optical axis and the maximum effective diameter of the optical system, thereby providing a slim and compact optical system.

Equation 56 may further include Equation 56-1. Here, nL is the number of lenses in the optical system, and may be 6 to 8, preferably 7.

$$0 < ( TTL / CA\_max ) / nL < 0.2 \qquad [ Equation 56 - 1 ]$$

$$0.4 < TTL / ( 2 * ImgH ) < 0.7 \qquad [ Equation 57 ]$$

Equation 57 may set the total length TTL in the optical axis of the optical system and the diagonal length (2*ImgH) of the image sensor 300. When the optical system 1000 according to the embodiment satisfies Equation 47, the optical system 1000 may have a smaller TTL by securing a BFL (Back local length) for the application of a relatively large image sensor 300, for example, a large image sensor 300 of about 1 inch, and may have a high-definition implementation and a slim structure.

Equation 57 may further include Equation 57-1. Here, nL is the number of lenses in the optical system, and may be 6 to 8, preferably 7.

$$0 < ( TTL / ( 2 * ImgH ) ) / nL < 0.2 \qquad [ Equation 57 - 1 ]$$

$$0.01 < BFL / ImgH < 0.5 \qquad [ Equation 58 ]$$

Equation 58 may set the distance between the optical axis between the image sensor 300 and the last lens and the length in the diagonal direction from the optical axis of the image sensor 300. When the optical system 1000 according to the embodiment satisfies Equation 58, the optical system 1000 may secure a BFL to apply a relatively large image sensor 300, for example, a large image sensor 300 of around 1 inch, and minimize the distance between the last lens and the image sensor 300, thereby having good optical characteristics at the center and periphery portion of the FOV.

Equation 58 may further include Equation 58-1. Here, nL is the number of lenses in the optical system, and may be 6 to 8, preferably 7.

$$0 < ( BFL / ImgH ) / nL < 0.1 \qquad [ Equation 58 - 1 ]$$

$$4 < TTL / BFL < 10 \qquad [ Equation 59 ]$$

Equation 59 may set (unit, mm) the total optical axis length (TTL) of the optical system and the optical axis distance (BFL) between the image sensor 300 and the last lens. In the invention, since the sensor-side surface of the last lens has no critical point, the value of Equation 59 may be 5 mm or more or 6 mm or more. When the optical system 1000 according to the embodiment satisfies Equation 59, the optical system 1000 secures the BFL and may be provided slim and compact.

Equation 59 may further include Equation 59-1. Here, nL is the number of lenses in the optical system, and may be 6 to 8, preferably 7.

$$0.3 < ( TTL / BFL ) / nL < 1 \qquad [ Equation 58 - 1 ]$$

$$0.5 < F / TTL < 1.2 \qquad [ Equation 60 ]$$

Equation 60 may set the first and second direction averages of the total focal lengths F of the optical system 1000 and the total length TTL in the optical axis. Accordingly, a slim and compact optical system may be provided.

Equation 60 may further include Equation 60-1. Here, nL is the number of lenses in the optical system, and may be 6 to 8, preferably 7.

$$0 < ( F / TTL ) / nL < 0.3 \qquad [ Equation 60 - 1 ]$$

$$3 < F / BFL < 10 \qquad [ Equation 61 ]$$

Equation 61 may set (unit, mm) the total focal length F of the optical system 1000 and the optical axis distance (BFL) between the image sensor 300 and the last lens. In the invention, since the sensor-side surface of the last lens has no critical point, the BFL value is narrower, so the value of Equation 61 may be 5 mm or more. When the optical system 1000 according to the embodiment satisfies Equation 61, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV.

Equation 61 may further include Equation 61-1. Here, nL is the number of lenses in the optical system, and may be 6 to 8, preferably 7.

$$0.2 < ( F / TTL ) / nL < 3 \qquad [ Equation 61 - 1 ]$$

$$0.1 < F / ImgH < 3 \qquad [ Equation 62 ]$$

Equation 62 may set the total focal length F (mm) of the optical system 1000 and the diagonal length ImgH of the optical axis of the image sensor 300. The optical system 1000 may have improved aberration characteristics by applying a relatively large image sensor 300, for example, a large image sensor 300 of around 1 inch.

Equation 62 may further include Equation 62-1. Here, nL is the number of lenses in the optical system, and may be 6 to 8, preferably 7.

$$0 < ( F / Imgh ) / nL < 0.3 \qquad [ Equation 62 - 1 ]$$

$$1 \leq F / EPD < 5 \qquad [ Equation 63 ]$$

Equation 63 may set the total focal length F (mm) of the optical system 1000 and the entrance pupil size. Accordingly, the overall brightness of the optical system may be controlled.

Equation 63 may further include Equation 63-1. Here, nL is the number of lenses in the optical system, and may be 6 to 8, preferably 7.

$$0.1 < ( F / EPD ) / nL < 0.4 \qquad [ Equation 63 - 1 ]$$

$$1 < F / CA\_L1S1 < 2 \qquad [ Equation 64 ]$$

In Equation 64, CA_L1S1 is an effective diameter of the object-side surface of the first lens 101. The optical system may set the average of the effective focal lengths in the first and second directions and the incident-side effective diameter by Equation 64.

$$50 < Inf 62 * L6S2\_Max \_slope < 120 \qquad [ Equation 65 ]$$

The Inf62 is the average value of the distances from the optical axis to the critical points in the first and second directions X and Y of the twelfth sensor-side surface S12 of the sixth lens 106, and L6S2_Max_slope is the maximum angle between the optical axis OA and the normal line perpendicular to the tangent line passing through any point on the sensor-side surface S12 of the sixth lens 106. When Equation 65 is satisfied, good optical performance may be obtained in the periphery portion of the image sensor 300 by adjusting the refractive angle of the sensor-side surface of the sixth lens 106 having a freeform surface. Here, * represents multiplication.

$$30 < Inf 72 * L7S2\_Max \_slope < 110 \qquad [ Equation 66 ]$$

The Inf72 is the average value of the distances from the optical axis to the critical points in the first and second directions X and Y of the fourteenth sensor-side surface S14 of the seventh lens 107, and L7S2_Max_slope is the maximum angle between the optical axis OA and the normal line perpendicular to the tangent line passing through any point on the fourteenth sensor-side surface S14 of the seventh lens 107. When Equation 66 is satisfied, good optical performance may be obtained in the periphery portion of the image sensor 300 by adjusting the refractive angle of the sensor-side surface of the seventh lens 107 having a freeform surface.

$$0.7 < Inf 61 / Inf 62 < 1.2 \qquad [ Equation 67 ]$$

Inf61 and Inf62 represent average values of the distances from the optical axis to the critical points in the first and second directions X and Y of the object-side eleventh surface S11 and the sensor-side twelfth surface S12 of the sixth lens 106. When Equation 67 is satisfied, by adjusting the lens surface of the sixth lens 106 having a freeform surface, good optical performance may be obtained in the periphery portion of the image sensor 300.

$$0.2 < Inf 71 / Inf 72 < 1 \qquad [ Equation 68 ]$$

The Inf71 and Inf72 mean average values of the distances from the optical axis to the critical points in the first and second directions X and Y of the thirteenth object-side surface S13 and the sensor-side fourteenth surface S14 of the seventh lens 107. When Equation 68 is satisfied, by adjusting the lens surface of the seventh lens 106 having a freeform surface, good optical performance may be obtained in the periphery portion of the image sensor 300.

$$45 < L6S2x\_max slope < 70 \qquad [ Equation 69 ]$$

The L6S2x_max slope is the maximum angle formed by a normal line perpendicular to a tangent line passing through an arbitrary point in the first direction X of the sensor-side twelfth surface S12 of the sixth lens 106 and the optical axis OA.

$$45 < L6S2y\_max slope < 70 \qquad [ Equation 70 ]$$

The L6S2y_max slope is the maximum angle formed by a normal line perpendicular to a tangent line passing through an arbitrary point in the second direction Y of the sensor-side twelfth surface S12 of the sixth lens 106 and the optical axis OA. A value of the L6S2y_max slope and a value of the L6S2y_max slope may be different from each other.

$$0.5 < CA\_L6S2x / CA\_L6S2y < 1 \qquad [ Equation 71 ]$$

The CA_L6S2x is an effective diameter in the first direction X of the sensor-side twelfth surface S12 of the sixth lens 106, and the CA_L6S2y is the effective diameter in the second direction Y of the sensor-side twelfth surface S12 of the sixth lens 106. According to Equation 71,

the effective diameter of the sensor-side surface of the sixth lens 106 having a free curved surface may be different in the first and second directions orthogonal to the optical axis and the axial directions (30 degrees, 45 degrees, 53 degrees, 60 degrees, etc.) between them.

$$45 < \vert L7S2x\_max slope \vert < 70 \qquad [ Equation 72 ]$$

The L7S2x_max slope is the maximum angle formed by a normal line perpendicular to a tangent line passing through an arbitrary point in the first direction X of the sensor-side fourteenth surface S14 of the seventh lens 107 and the optical axis OA.

$$45 < \vert L7S2y\_max slope \vert < 70 \qquad [ Equation 73 ]$$

The L7S2y_max slope is the maximum angle formed by a normal line perpendicular to a tangent line passing through an arbitrary point in the second direction Y of the sensor-side fourteenth surface S14 of the seventh lens 107 and the optical axis OA. A value of the L7S2y_max slope and a value of the L7S2y_max slope may be different from each other.

$$1 < CA\_L7S2x / CA\_L7S2y < 1.2 \qquad [ Equation 74 ]$$

The CA_L7S2x is an effective diameter in the first direction X of the sensor-side fourteenth surface S14 of the seventh lens 107, and the CA_L7S2y is the effective diameter in the second direction Y of the sensor-side fourteenth surface S14 of the seventh lens 107. According to Equation 75, the effective diameter of the sensor-side surface of the seventh lens 107 having a freeform surface may be different in the first and second directions orthogonal to the optical axis and the axial directions (30 degrees, 45 degrees, 53 degrees, 60 degrees, etc.) between them.

$$1 < D34\_CT / D34\_ET < 8 \qquad [ Equation 75 ]$$

The D34_CT is a center distance between the third and fourth lenses 103 and 104, and D34_ET is a distance between the third and fourth lenses 103 and 104 at the end of the effective region. That is, D34_ET is a distance in the optical axis between the end of the effective region of the sensor-side surface of the third lens 103 and the end of the effective region of the object-side surface of the fourth lens 104. When Equation 75 is satisfied, the optical system may improve chromatic aberration by reducing it.

$$1 < D56\_CT / D56\_ET < 3 \qquad [ Equation 76 ]$$

D56_CT is the distance between the centers of the fifth and sixth lenses 105 and 106, and D56_ET is the distance between the fifth and sixth lenses 105 and 106 at the end of the effective region. That is, D56_ET is a distance in the optical axis between the end of the effective region of the sensor-side surface of the fifth lens 105 and the end of the effective region of the object-side surface of the sixth lens 106. When Equation 76 is satisfied, the optical system may improve distortion and chromatic aberration at the periphery portion of the FOV.

$$0 < D67\_max / D67\_CT < 2 \qquad [ Equation 77 ]$$

D67_Max is the maximum distance among the distances between the sixth and seventh lenses 106 and 107, and D67_CT is the center distance between the sixth and seventh lenses 106 and 107. When Equation 77 is satisfied, the optical system may improve distortion and chromatic aberration at the periphery portion of the FOV by adjusting the distance between the last two lenses.

$$0.01 < D12\_CT / D67\_CT < 1 \qquad [ Equation 78 ]$$

The D12_CT is the center distance between the first and second lenses 101 and 102. When Equation 78 is satisfied, the aberration characteristics of the optical system may be improved and a slim optical system may be designed.

$$1 < D67\_CT / D67\_Min < 10 \qquad [ Equation 79 ]$$

The D67_Min represents the minimum distance among the distances between the sixth and seventh lenses 106 and 107. When Equation 79 is satisfied, the optical system may reduce the effect of distortion aberration and improve the peripheral image quality.

$$0 < L7\_ET / L7\_CT < 1.2 \qquad [ Equation 80 ]$$

The L7_ET is the thickness in the optical axis direction at the end of the effective region of the seventh lens 107. When Equation 80 is satisfied, the effect of distortion aberration may be reduced. The thickness in the optical axis direction at the end of the effective region is the optical axis distance between the end of the effective region of the object-side surface of each lens and the end of the effective region of the sensor-side surface of each lens.

$$0.5 < L 3 \_CT / L3\_ET < 2 \qquad [ Equation 81 ]$$

L3_ET is the thickness of the third lens 103 in the optical axis direction at the end of the effective region. When Equation 81 is satisfied, the effect of chromatic aberration may be reduced.

$$1 < D67\_CT / CD67\_ET < 5 \qquad [ Equation 82 ]$$

The D67_CT and D67_ET indicate the distance between the center and the end of the effective region among the distances between the sixth and seventh lenses 106 and 107. When Equation 82 is satisfied, the optical system may improve distortion and chromatic aberration at the periphery portion of the FOV by adjusting the distance between the last two lenses.

$$Z = \frac{{cY}^{2}}{1 + \sqrt{1 - ( 1 + K ) {c}^{2} {Y}^{2}}} + A {Y}^{4} + {BY}^{6} + {CY}^{8} + {DY}^{10} + {EY}^{12} + {FY}^{14} + … \qquad [ Equation 83 ]$$

In Equation 83, Z is a Sag value, and may mean a distance in the optical axis direction from an arbitrary position on the aspherical surface to the apex of the aspheric surface. The Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants. In the practice of the invention, an aspheric surface may be provided from the first surface S1, which is L1S1, to the tenth surface S10, which is L5S2.

$$\tilde{z} ( \tilde{x} , \tilde{y} ) = {z}_{b a s e} ( \tilde{x} , \tilde{y} ) + \frac{δ ( \tilde{u} , \tilde{θ} )}{σ ( \tilde{r} )} \qquad [ Equation 84 ]$$

Equation 84 is a coefficient for freeform surfaces of the object-side surface and the sensor-side surface of the sixth and seventh lenses 106 and 107, and may be expressed as an 80th order coefficient as shown in FIGS. 7 and 13 as an SPS Q2D surface equation. Here, a variable with a tilde (˜) represents a parameter of an off-axis coordinate system.

The optical system 1000 according to the embodiment may satisfy at least one or two or more of Equations 1 to 82. In this case, the optical system 1000 may have improved optical characteristics. In detail, when the optical system 1000 satisfies at least one or two or more of Equations 1 to 82, the optical system 1000 has improved resolution and may improve aberration and distortion characteristics. In addition, the optical system 1000 may secure a BFL (Back focal length) for applying the large-size image sensor 300, and may minimize the distance between the last lens and the image sensor 300, so it may have good optical performance in the center and periphery portion of the FOV. In addition, when the optical system 1000 satisfies at least one of Equations 1 to 70, it may include a relatively large image sensor 300, have a relatively small TTL value, and be slimmer. It is possible to provide a compact optical system and a camera module having the same.

In the optical system 1000 according to the embodiment, the distance between the plurality of lenses 100 may have a value set according to the region.

FIG. 5 is an example of lens data according to a first embodiment having the optical system of FIG. 1, and FIG. 11 is an example of lens data according to a second embodiment having the optical system of FIG. 1.

As shown in FIGS. 5 and 11, the optical system according to the first and second embodiments represents a curvature radius, the thickness of each lens, the distance between the lenses on the optical axis OA of the first to seventh lenses 101 to 107, the refractive index at d-line (588 nm), Abbe number, and the size of the effective diameter CA (clear aperture). The F number in the invention may be different from each other in the first direction and the second direction, and may be 1.5 or more, for example, in the range of 1.5 to 2.5. At least one or both of the object-side surface and the sensor-side surface of the sixth lens 106 may be provided with a freeform surface, and at least one or both of the object-side surface and the sensor-side surface of the seventh lens 107 may be provided with freeform surface. A curved surface may be provided. Accordingly, the optical performance of the periphery portion of the FOV may be corrected satisfactorily;

Table 1 relates to the items of the above described equations in the optical system 1000 according to the first to third embodiments, including TTL (Total track length) of the optical system 1000, BFL (Back focal length), and total effective focus, a distance F value, ImgH, focal lengths (F1, F2, F3, F4, F5, F6, F7) of each of the first to seventh lenses, a composite focal length and the like.

TABLE 1

| Items | First embodiment | Second embodiment |
|---|---|---|
| F | 7.260 | 7.494 |
| EFLx | 7.267 | 7.501 |
| EFLy | 7.253 | 7.487 |
| F1 | 21.284 | 20.547 |
| F2 | 8.490 | 9.021 |
| F3 | −18.026 | −20.498 |
| F4 | 31.067 | 33.728 |
| F5 | −12.371 | −12.629 |
| F6 | 7.914 | 7.733 |
| F6x | 7.833 | 7.660 |
| F6y | 7.994 | 7.806 |
| F7 | −5.048 | −4.197 |
| F7x | −5.001 | −4.162 |
| F7y | −5.089 | −4.233 |
| F13 | 8.651 | 8.575 |
| F47 | −13.292 | −9.545 |
| F47x | −13.328 | −9.537 |
| F47y | −13.256 | −9.553 |
| Inf62 | 7.462 | 7.462 |
| InfX62 | 2 | 2 |
| InfY62 | 2 | 2 |
| Inf72 | 1.9 | 1.9 |
| InfX72 | 2 | 2 |
| InfY72 | 1.8 | 1.8 |
| EPD | 3.719 | 3.815 |
| BFL | 1.174 | 1.216 |
| Imgh | 7.935 | 7.935 |
| TTL | 7.930 | 7.930 |
| F-number | 1.952 | 1.964 |
| F-number_X | 1.954 | 1.966 |
| F-number_Y | 1.950 | 1.963 |
| FOV | 88 degrees | 88 degrees |

Table 2 is a table showing the edge distance AIR ET (mma) and edge thickness ET (mm) of the first to seventh lenses L1 to L7 according to the first and second embodiments having the optical system 1000 of FIG. 1,

TABLE 2

| Edge thickness of each lens | | | Edge spacing of two adjacent lenses | | |
|---|---|---|---|---|---|
| | First | Second | | First | Second |
| | embodiment | embodiment | | embodiment | embodiment |
| ET1 | 0.339 | 0.330 | Air_Edge12 | 0.2886 | 0.304 |
| ET2 | 0.236 | 0.215 | Air_Edge23 | 0.2487 | 0.267 |
| ET3 | 0.499 | 0.482 | Air_Edge34 | 0.3457 | 0.317 |
| ET4 | 0.200 | 0.204 | Air_Edge45 | 0.4544 | 0.451 |
| ET5 | 0.202 | 0.200 | Air_Edge56 | 0.1355 | 0.119 |
| ET6 | 0.344 | 0.331 | Air_Edge67 | 0.6357 | 0.672 |
| ET7 | 0.399 | 0.399 | | | |

Table 3 shows the resultant values of Equations: 1 to 55 in the optical system 1000 of FIG. 1, Referring to Table 3, it may be seen that the optical system 1000 satisfies at least one, two or more, or three or more of Equations 1 to 55, In detail, it may be seen that the optical system 1000 according to the embodiment satisfies all of Equations 1 to 55 above. Accordingly, the optical stem 1000 may improve center and periphery portions of the FOV.

TABLE 3

| Equations | | First embodiment | Second embodiment |
|---|---|---|---|
| 1 | 1 < L1_CT/L3_CT < 5 | 1.47 | 1.48 |
| 2 | 0.5 < L3_CT/L4_CT < 2 | 1.303 | 1.314 |
| 3 | 0 < L7_CT/L6_CT < 2 | 0.728 | 0.721 |
| 4 | 1 < L1_CT/L7_CT < 3 | 1.239 | 1.213 |
| 5 | 0 < L7_CT/L2_CT < 1 | 0.668 | 0.693 |
| 6 | 1 < L2_CT/L3_CT < 3.0 | 1.782 | 1.755 |
| 7 | 0.01 < D12_CT/D67_CT < 1 | 0.053 | 0.053 |
| 8 | 1 < G1_CT/D34 < 5 | 1.920 | 1.906 |
| 9 | 1 < G2_CT/D67 < 5 | 2.567 | 2.629 |
| 10 | 0 < (L6_CT + L7_CT)/D67 < 1 | 0.634 | 0.673 |
| 11 | 0 < L1R1/L7R2 < 5 | 0.698 | 0.699 |
| 12 | 10 < (\|L5R2\|/L2_CT)/nL < 90 | 48.597 | 15.868 |
| 13 | 0 < L6_CT/D67_CT < 1 | 0.367 | 0.391 |
| 14 | 0 < (D67_CT)/InfX72 < 1.2 | 0.818 | 0.792 |
| 15 | 0 < (D67_CT)/InfY72 < 1.2 | 0.908 | 0.880 |
| 16 | 0 < (D67_CT)/Inf72 < 1.2 | 0.861 | 0.834 |
| 17 | 1.60 < n3 | 1.681 | 1.534 |
| 18 | 0.5 < n2/n3 < 1.2 | 0.924 | 1.035 |
| 19 | 1.65 < AVR(n3, n5) < 1.75 | 1.681 | 1.534 |
| 20 | 1 < CA_L1S1/CA_L3S1 < 1.5 | 1.231 | 1.256 |
| 21 | 1 < CA_L7S2/CA_LAS2 < 5 | 2.855 | 2.843 |
| 22 | 0.2 < CA_L3S2/CA_L4S1 < 2 | 0.941 | 0.941 |
| 23 | 0.1 < CA_L5S2/CA_L7S2 < 1 | 0.552 | 0.559 |
| 24 | 1 < \|L6R1/L6_CT\| < 30 | 12.197 | 11.689 |
| 25 | 1 < \|LSR1/L7R1\| < 100 | 1.331 | 1.349 |
| 26 | 0 < L2R1/\|L2R2\| < 1.0 | 0.021 | 0.066 |
| 27 | 0 < L3R2/\|L3R1\| < 1.0 | 0.679 | 0.723 |
| 28 | 0 ≤ \|EFLX − EFLY\| ≤ 0.1 | 0.015 | 0.014 |
| 29 | 0 < L_CT_Max/Air_CT_Max < 5 | 0.40 | 0.41 |
| 30 | 0.5 < ΣL_CT/ΣAir_CT < 2 | 0.864 | 1.003 |
| 31 | 9 < ΣIndex < 30 | 11.159 | 11.154 |
| 32 | 10 < ΣAbb/ΣIndex < 50 | 3.539 | 25.443 |
| 33 | 0.5 < CA_L1S1/CA_min < 2 | 1.338 | 1.365 |
| 34 | 1 < CA_max/CA_min < 5 | 3.333 | 3.334 |
| 35 | 1 < CA_max/CA_Aver < 3 | 2.148 | 2.131 |
| 36 | 0.1 < CA_min/CA_Aver < 1 | 0.644 | 0.639 |
| 37 | 0.1 < CA_max/(2*ImgH) < 1 | 0.672 | 0.672 |
| 38 | 0.5 < TD/CA_max < 1.5 | 0.633 | 0.629 |
| 39 | 0 < \|F/L7R2\| < 10 | 1.704 | 1.774 |
| 40 | 1 < F/L1R1 < 10 | 2.441 | 2.538 |
| 41 | 0 < \|(EPD/L7R2)\| < 10 | 0.469 | 0.478 |
| 42 | 0.5 < EPD/L1R1 < 8 | 1.250 | 1.292 |
| 43 | −3 < F1/F3 < 0 | −1.181 | −1.002 |
| 44 | 0 < F13/F < 5 | 1.192 | 1.154 |
| 45 | 0 < \|F47/F13\| < 4 | 1.532 | 1.532 |
| 46 | 0 < f2/F < 5 | 1.169 | 1.204 |
| 47 | −5 < F2/F3 < 0 | −0.471 | −0.440 |
| 48 | 0 < F2/F27 < 1.0 | 0.450 | 0.479 |
| 49 | 0 < F2/F12 < 5 | 1.332 | 1.415 |
| 50 | 1 < F27/F < 5 | 2.596 | 2.515 |
| 51 | 2 < TTL < 20 | 7.930 | 7.930 |
| 52 | 2 < ImgH | 7.935 | 7.935 |
| 53 | BFL < 2.5 | 1.174 | 1.216 |
| 54 | 2 < F < 20 | 7.260 | 7.494 |
| 55 | FOV < 120 | 88.000 | 88.000 |

Table 4 shows the resultant values of Equations 56 to 82 in the optical system 1000 of FIG. 1. Referring to Table 4, it may be seen that the optical system 1000 satisfies at least one, two or more, or three or more of Equations 56 to 82. In detail, it may be seen that the optical system 1000 according to the embodiment satisfies all of Equations 56 to 82 above. Also, at least one of Equations 56 to 82 may satisfy at least one or two or more of Equations 1 to 5$. Accordingly, the optical system 1000 may improve optical performance and optical characteristics at the center and periphery portions of the FOV:

TABLE 4

| Equations | | First embodiment | Second embodiment |
|---|---|---|---|
| 56 | 0.5 < TTL/CA_max < 1 | 0.744 | 0.743 |
| 57 | 0.4 < TTL/(ImgH*2) < 0.7 | 0.500 | 0.500 |
| 58 | 0.01 < BFL/ImgH < 0.2 | 0.148 | 0.153 |
| 59 | 0 < BFL/TTL < 0.3 | 0.148 | 0.153 |
| 60 | 0.5 < F/TTL < 1.2 | 0.916 | 0.945 |
| 61 | 3 < F/BFL < 10 | 6.185 | 6.162 |
| 62 | 0.1 < F/ImgH < 3 | 0.915 | 0.944 |
| 63 | 1 < F/EPD < 3 | 1.952 | 1.964 |
| 64 | 1 < F/CA_L1S1 < 2 | 1.696 | 1.716 |
| 65 | 50 < Inf62*L6S2_Max_slope < 120 | 117.73 | 118.06 |
| 66 | 30 < Inf72*L7S2_Max_slope < 110 | 99.83 | 100.28 |
| 67 | 0.7 < Inf61/Inf62 < 1.2 | 0.952 | 0.952 |
| 68 | 0.2 < Inf71/Inf72 < 1 | 0.444 | 0.444 |
| 69 | 45 < \|L6S2x_max slope\| < 70 | 52.744 | 53.888 |
| 70 | 45 < \|L6S2y_max slope\| < 70 | 53.293 | 55.088 |
| 71 | 0.5 < CA_L6S2x/CA_L6S2y < 1 | 0.990 | 0.978 |
| 72 | 45 < \|L7S2x_max slope\| < 70 | 52.545 | 52.779 |
| 73 | 45 < \|L7S2y_max slope\| < 70 | 50.821 | 50.504 |
| 74 | 1 < CA_L7S2x/CA_L7S2y < 1.2 | 1.034 | 1.045 |
| 75 | 1 < D34_CT/D34_ET < 8 | 2.536 | 2.762 |
| 76 | 1 < D56_CT/D56_ET < 3 | 4.976 | 5.509 |
| 77 | 0 < D67_max/D67_CT < 2 | 1.020 | 1.023 |
| 78 | 0.01 < D12_CT/D67_CT < 1 | 0.577 | 0.547 |
| 79 | 1 < D67_CT/D67_min < 10 | 0.986 | 0.981 |
| 80 | 0 < L7_ET/L7_CT < 1.2 | 0.914 | 0.740 |
| 81 | 0.5 < L3_CT/L3_ET < 2 | 0.736 | 1.709 |
| 82 | 1 < D67_CT/D67_ET < 5 | 2.572 | 2.359 |

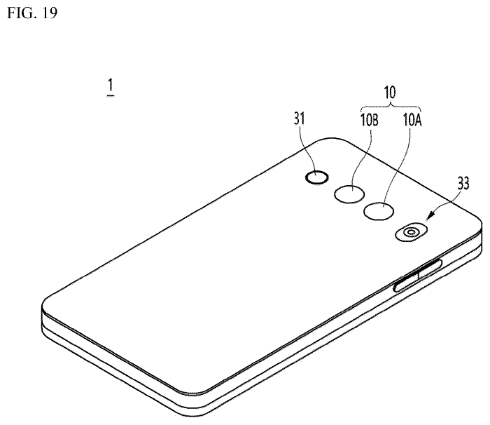

FIG. 19 is a diagram illustrating that a camera module according to an embodiment is applied to a mobile terminal.

Referring to FIG. 19, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy.

In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention.

In addition, although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1-23. (canceled)

24. An optical system comprising:
first to seventh lenses arranged along an optical axis from an object side toward a sensor side,
wherein an object-side surface of the first lens is convex,
wherein at least one of an object-side surface and a sensor-side surface of the sixth lens has at least one critical point,
wherein each of an object-side surface and a sensor-side surface of the seventh lens has a critical point,
wherein at least one of the object-side surface and the sensor-side surface of the seventh lens has a freeform surface shape in which a lens surface orthogonal to the optical axis in a first direction and a lens surface orthogonal to the optical axis in a second direction are asymmetrical,
wherein the freeform surface has symmetrical lens surfaces on both sides of the first direction with respect to the optical axis and symmetrical lens surfaces on both sides of the second direction with respect to the optical axis,
wherein a sensor-side surface of the third lens has a concave shape on the optical axis,
wherein an object-side surface of the fourth lens has a concave shape on the optical axis, and
wherein a center distance between the sixth lens and the seventh lens is a maximum among center distances between the first to seventh lenses.

25. The optical system of claim 24, wherein each of the object-side surface and the sensor-side surface of the sixth lens has the critical point, and
wherein the critical point of the object-side surface of the seventh lens is located closer to the optical axis than the critical points of the object-side surface and the sensor-side surface of the sixth lens.

26. The optical system of claim 24, wherein the sixth lens includes regions having different thicknesses at the same radial position in the first direction and the second direction with respect to the optical axis.

27. The optical system of claim 24, wherein the seventh lens includes regions having different thicknesses at the same radial position in the first direction and the second direction with respect to the optical axis.

28. The optical system of claim 26, wherein the sixth lens includes regions having different thicknesses within the same radius in different axial directions between the first direction and the second direction orthogonal to the optical axis, and
wherein the seventh lens includes regions having different thicknesses within the same radius in different axial directions between the first direction and the second direction orthogonal to the optical axis.

29. The optical system of claim 24, wherein a maximum angle between a normal line perpendicular to a tangent passing through the sensor-side surface of the sixth lens and the optical axis has different angles in the first direction and the second direction orthogonal to the optical axis, and
wherein a maximum angle between a normal line perpendicular to a tangent passing through the sensor-side surface of the seventh lens and the optical axis has different angles in the first direction and the second direction orthogonal to the optical axis.

30. The optical system of claim 24, wherein the first lens has positive refractive power and has a meniscus shape convex toward the object side on the optical axis, and
wherein the second and third lenses have refractive powers opposite to each other, and each has a meniscus shape convex toward the object side on the optical axis.

31. The optical system of claim 24, wherein the fourth lens has a positive refractive power,
wherein the fifth lens has negative refractive power, and
wherein a sum of the center thicknesses of the fourth and fifth lenses is greater than a center distance between the second and third lenses.

32. The optical system of claim 24, wherein the sixth lens has a positive refractive power, has the object-side surface having a convex shape and the sensor-side surface having a concave shape on the optical axis, and
wherein the seventh lens has negative refractive power, has the object-side surface having a convex shape and the sensor-side surface having a concave shape on the optical axis.

33. An optical system comprising:
first to seventh lenses disposed along an optical axis from an object side to a sensor side,
wherein the first lens has a convex object-side surface,
wherein at least one of an object-side surface and a sensor-side surface of the sixth lens has a freeform surface,
wherein each of an object-side surface and a sensor-side surface of the seventh lens has a critical point,
wherein at least one of the object-side surface and the sensor-side surface of the seventh lens has a freeform surface shape in which a lens surface orthogonal to the optical axis in a first direction and a lens surface orthogonal to the optical axis in a second direction are asymmetrical, and, the following Equation satisfies:
$$Equation : 0 \leq \vert EFLY - EFLY \vert \leq 0.1$$
where EFLX is an effective focal length in the first direction, and EFLY is an effective focal length in the second direction,
wherein a sensor-side surface of the third lens has a concave shape on the optical axis,
wherein an object-side surface of the fourth lens has a concave shape on the optical axis, and
wherein a center distance between the sixth lens and the seventh lens is a maximum among center distances between the first to seventh lenses.

34. The optical system of claim 33, wherein the sensor-side surface of the sixth lens has a freeform surface shape having a critical point, and the following Equation satisfies:
$$Equation : 50 < Inf62 * L6S2\_Max \_slope < 120$$
where Inf62 is an average value of the critical points in the first and second directions of the sensor-side surface of the sixth lens, and L6S2_Max_slope is a maximum angle between the optical axis and a normal line perpendicular to a tangent passing through an arbitrary point on the sensor-side surface of the sixth lens.

35. The optical system of claim 33, wherein the sensor-side surface of the seventh lens is a freeform surface having a critical point,
$$Equation : 30 < Inf72 * L7S2\_Max \_slope < 110$$
where Inf72 is an average value of the critical points in the first and second directions of the sensor-side surface of the seventh lens, and L7S2_Max_slope is a maximum angle between the optical axis and a normal line perpendicular to a tangent passing through an arbitrary point on the sensor-side surface of the seventh lens, and
wherein the EFLX and EFLY have different values.

36. The optical system of claim 33, wherein the sensor-side surface of the seventh lens has a freeform surface, and
wherein the sensor-side surface of the seventh lens has a different distance from the optical axis to the critical point in the first direction and a distance to the critical point in the second direction.

37. The optical system of claim 36, wherein a center thickness of the second lens is a largest among center thicknesses of the first to seventh lenses.

38. The optical system of claim 24, wherein an average distance from the optical axis to the critical points in the first and second directions of the object-side surface of the seventh lens is Inf71, and an average distance from the optical axis to the critical points in the first and second directions of the sensor-side surface of the seventh lens is Inf72, and the following Equation satisfies:
$$Equation : 0.2 < Inf71 / Inf72 < 1$$
wherein the Inf71 and the Inf72 are different from each other, and
wherein the following Equation satisfies:
$$Equation \text{:} 0.4 < TTL / ( Imgh * 2 ) < 0.7$$
(TTL is a distance in the optical axis from an apex of the object-side surface of the first lens to an upper surface of an image sensor, and ImgH is ½ of a maximum diagonal length of the image sensor.).

39. An optical system comprising:
a first lens group having three or less lenses on an object side; and
a second lens group having four or less lenses on a sensor side of the first lens group,
wherein the first lens group has a positive (+) refractive power on the optical axis,
wherein the second lens group has a negative (−) refractive power on the optical axis,
wherein a number of lenses of the second lens group is less than twice a number of lenses of the first lens group,
wherein a lens surface closest to the second lens group among lens surfaces of the first and second lens groups has a smallest effective diameter,
wherein a last lens closest to the image sensor among the lens surfaces of the first and second lens groups has a largest effective diameter,
wherein a sensor-side surface closest to the second lens group in the first lens group has a concave shape,
wherein an object-side surface closest to the first lens group in the second lens groups has a concave shape,
wherein a sensor-side surface of the last lens closest to the image sensor in the first and second lens groups has a freeform surface shape with a critical point,
wherein a sensor side surface closest to the image sensor has a lens surface orthogonal to the optical axis in a first direction and a lens surface orthogonal to the optical axis in a second direction and has an asymmetric freeform surface, and
wherein the freeform surface has symmetrical lens surfaces on both sides of the first direction with respect to the optical axis and has symmetrical lens surfaces on both sides of the second direction.

40. The optical system of claim 39, wherein a focal length of the second lens group in the first direction and a focal length in the second direction are different from each other.

41. The optical system of claim 39, wherein an optical system that satisfies the following Equation:
$$Equation : 0.4 < TTL / ( Imgh * 2 ) < 0.7$$
(TTL is a distance in the optical axis from an apex of the object-side surface of the first lens to an upper surface of an image sensor, and ImgH is ½ of the maximum diagonal length of the image sensor.).

42. The optical system of claim 39, wherein the first lens group includes first to third lenses disposed along the optical axis from the object side toward the sensor side,
wherein the second lens group includes fourth to seventh lenses disposed along the optical axis from the object side toward the sensor side,
wherein each of an object-side surface and a sensor-side surface of the sixth lens is a freeform surface shape having a critical point, and
wherein an object-side surface of the seventh lens has a freeform surface shape having a critical point.

43. A camera module comprising:
an image sensor; and
a filter disposed between the image sensor and a last lens of an optical system,
wherein the optical system includes an optical system according to claim 33, and
wherein the camera module that satisfies the following Equations:
$$Equation : 5 < F / TTL < 1.2$$
$$Equation : 0 < ( F / TTL ) / nL < 0. 3$$
(F is an average of total focal lengths in two directions orthogonal to the optical axis of the optical system, TTL (Total track length) is a distance in the optical axis from an apex of the object-side surface of the first lens to an upper surface of the image sensor, and, nL is a total number of lenses.).
